(19) United States
(12) Patent Application Publication
(10) Pub. No.: US 2026/0180830 A1
(43) Pub. Date: Jun. 25, 2026

(54) BANDWIDTH PART SELECTION USING FMCW-BASED OFDM CHANNEL ESTIMATION

(71) Applicant: QUALCOMM Incorporated, San Diego, CA (US)

(72) Inventors: Kangqi LIU, San Diego, CA (US); Jing JIANG, San Diego, CA (US); Min HUANG, Beijing (CN); Hao XU, Beijing (CN); Weimin DUAN, San Diego, CA (US)

(21) Appl. No.: 19/127,678

(22) PCT Filed: Jan. 9, 2023
(86) PCT No.: PCT/CN2023/071197

§ 371 Date: May 6, 2025

(51) Int. Cl. H04L 25/02; H04L 5/00; H04L 27/26; H04W 72/0453

(52) U.S. Cl. CPC H04L 25/0224; H04L 5/0007; H04L 27/2602; H04W 72/0453

(57) ABSTRACT

Methods, systems, and devices for wireless communications are described. In some cases, a user equipment (UE) may transmit an indication of a capability of the UE to support channel estimation for wideband using signaling via a narrowband. The UE may receive a control signal indicating a resource occasion for communication of a frequency modulated continuous waveform (FMCW) signal via a first bandwidth part (BWP) of multiple BWPs. Additionally, the UE may receive, via the resource occasion and the first BWP of the multiple BWPs, the FMCW signal. As such, the UE may transmit a report indicating one or more second BWPs of the multiple BWPs of the wideband based on a channel estimation procedure associated with the multiple BWPs of the wideband, where the channel estimation is based on the FMCW signal.

### CROSS REFERENCE

The present Application is a 371 national phase filing of International PCT Application No. PCT/CN2023/071197 by LIU et al., entitled “BANDWIDTH PART SELECTION USING FMCW-BASED OFDM CHANNEL ESTIMATION,” filed Jan. 9, 2023, which is assigned to the assignee hereof, and which is expressly incorporated by reference in its entirety herein.

### FIELD OF TECHNOLOGY

The following relates to wireless communications, including bandwidth part selection using frequency modulated continuous waveform (FMCW)-based orthogonal frequency division multiplexing (OFDM) channel estimation.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

### SUMMARY

The described techniques relate to improved methods, systems, devices, and apparatuses that support bandwidth part (BWP) selection using frequency modulated continuous waveform (FMCW)-based orthogonal frequency division multiplexing (OFDM) channel estimation. Generally, the techniques described herein may enable a wireless device, such as a user equipment (UE), communicating via a first BWP from a set of BWPs associated with a wideband, to perform FMCW-based OFDM channel estimation of the wideband to select a second BWP from the set of BWPs. For example, a UE may transmit an indication of a capability of the UE to support channel estimation for a wideband (e.g., associated with the set of BWPs) using signaling via a narrowband (e.g., received via the first BWP), where the narrowband is associated with a bandwidth that is less than a threshold and the wideband is associated with a bandwidth that is greater than the threshold. The UE may receive a control signal indicating a resource occasion for communication of an FMCW signal via the first BWP of the set of BWPs of the wideband and may receive, via the resource occasion and the first BWP, the FMCW signal. As such, the UE may perform a channel estimation procedure associated with the set of BWPs of the wideband based on the FMCW signal and may transmit a report indicating one or more second BWPs of the set of BWPs based on the channel estimation procedure.

A method for wireless communications at a UE is described. The method may include transmitting an indication of a capability of the UE to support channel estimation for a wideband using signaling via a narrowband, where the narrowband is associated with a bandwidth that is less than a threshold bandwidth, and where the wideband is associated with a bandwidth that is greater than the threshold bandwidth, receiving a control signal indicating a resource occasion for communication of a FMCW signal via a first BWP of a set of multiple BWPs of the wideband, receiving, via the resource occasion and the first BWP of the set of multiple BWPs, the FMCW signal, and transmitting a report indicating one or more second BWPs of the set of multiple BWPs of the wideband based on a channel estimation procedure associated with the set of multiple BWPs of the wideband, where the channel estimation procedure is based on the FMCW signal.

An apparatus for wireless communications at a UE is described. The apparatus may include a processor, memory coupled with the processor, and instructions stored in the memory. The instructions may be executable by the processor to cause the apparatus to transmit an indication of a capability of the UE to support channel estimation for a wideband using signaling via a narrowband, where the narrowband is associated with a bandwidth that is less than a threshold bandwidth, and where the wideband is associated with a bandwidth that is greater than the threshold bandwidth, receive a control signal indicating a resource occasion for communication of a FMCW signal via a first BWP of a set of multiple BWPs of the wideband, receive, via the resource occasion and the first BWP of the set of multiple BWPs, the FMCW signal, and transmit a report indicating one or more second BWPs of the set of multiple BWPs of the wideband based on a channel estimation procedure associated with the set of multiple BWPs of the wideband, where the channel estimation procedure is based on the FMCW signal.

Another apparatus for wireless communications at a UE is described. The apparatus may include means for transmitting an indication of a capability of the UE to support channel estimation for a wideband using signaling via a narrowband, where the narrowband is associated with a bandwidth that is less than a threshold bandwidth, and where the wideband is associated with a bandwidth that is greater than the threshold bandwidth, means for receiving a control signal indicating a resource occasion for communication of a FMCW signal via a first BWP of a set of multiple BWPs of the wideband, means for receiving, via the resource occasion and the first BWP of the set of multiple BWPs, the FMCW signal, and means for transmitting a report indicating one or more second BWPs of the set of multiple BWPs of the wideband based on a channel estimation procedure associated with the set of multiple BWPs of the wideband, where the channel estimation procedure is based on the FMCW signal.

A non-transitory computer-readable medium storing code for wireless communications at a UE is described. The code may include instructions executable by a processor to transmit an indication of a capability of the UE to support channel estimation for a wideband using signaling via a narrowband, where the narrowband is associated with a bandwidth that is less than a threshold bandwidth, and where the wideband is associated with a bandwidth that is greater than the threshold bandwidth, receive a control signal indicating a resource occasion for communication of a FMCW signal via a first BWP of a set of multiple BWPs of the wideband, receive, via the resource occasion and the first BWP of the set of multiple BWPs, the FMCW signal, and transmit a report indicating one or more second BWPs of the set of multiple BWPs of the wideband based on a channel estimation procedure associated with the set of multiple BWPs of the wideband, where the channel estimation procedure is based on the FMCW signal.

In some examples of the method, apparatuses, and non-transitory computer-readable medium described herein, transmitting the indication of the capability of the UE may include operations, features, means, or instructions for transmitting an indication of one or more time thresholds associated with switching from receiving a first type of signaling to receiving a second type of signaling, switching from receiving the second type of signaling to receiving the first type of signaling, performing the channel estimation procedure, or any combination thereof.

In some examples of the method, apparatuses, and non-transitory computer-readable medium described herein, the first type of signaling may be FMCW signaling and the second type of signaling may be OFDM signaling.

In some examples of the method, apparatuses, and non-transitory computer-readable medium described herein, receiving the indication of the resource occasion may include operations, features, means, or instructions for receiving an indication of a start time, a start frequency, a duration, a bandwidth, a slope, or any combination thereof, associated with the FMCW signal, where the resource occasion may be based on the start time, the start frequency, the duration, the bandwidth, the slope, or any combination thereof.

In some examples of the method, apparatuses, and non-transitory computer-readable medium described herein, the duration includes one or more symbol lengths, a portion of a symbol length, one or more slot lengths, a portion of a slot length, a length of a CP, or any combination thereof.

Some examples of the method, apparatuses, and non-transitory computer-readable medium described herein may further include operations, features, means, or instructions for receiving an indication of one or more resources associated with communicating the report indicating one or more second BWPs, where the report may be transmitted via the one or more resources.

In some examples of the method, apparatuses, and non-transitory computer-readable medium described herein, the control signal includes the indication of the one or more resources.

In some examples of the method, apparatuses, and non-transitory computer-readable medium described herein, the indication of the one or more resources may be received via a second control signal and the second control signal includes DCI, a MAC-CE, or RRC signaling.

Some examples of the method, apparatuses, and non-transitory computer-readable medium described herein may further include operations, features, means, or instructions for receiving a second control signal indicating a set of BWP configurations, where the report includes an indication of a first BWP configuration from the set of BWP configurations, and where the first BWP configuration may be associated with the one or more second BWPs.

In some examples of the method, apparatuses, and non-transitory computer-readable medium described herein, the control signal includes DCI, a MAC-CE, or a RRC signal.

In some examples of the method, apparatuses, and non-transitory computer-readable medium described herein, the control signal may be a dynamic indication of the resource occasion or a semi-persistent indication of the resource occasion.

Some examples of the method, apparatuses, and non-transitory computer-readable medium described herein may further include operations, features, means, or instructions for performing the channel estimation procedure based on samples of a combined FMCW signal, the combined FMCW signal including a combination of the received FMCW signal and a second FMCW signal generated at the UE.

In some examples of the method, apparatuses, and non-transitory computer-readable medium described herein, performing the channel estimation procedure may include operations, features, means, or instructions for estimating the set of multiple BWPs of the wideband based on extracting the wideband from the combined FMCW signal.

In some examples of the method, apparatuses, and non-transitory computer-readable medium described herein, the received FMCW signal may be associated with the wideband and the combined FMCW signal may be associated with the narrowband.

Some examples of the method, apparatuses, and non-transitory computer-readable medium described herein may further include operations, features, means, or instructions for receiving a second control signal indicating at least one BWP of the one or more second BWPs based on the report and communicating via the at least one BWP of the one or more second BWPs.

In some examples of the method, apparatuses, and non-transitory computer-readable medium described herein, the first BWP may be of one or more BWPs associated with the narrowband.

A method for wireless communications at a network entity is described. The method may include receiving an indication of a capability of a UE to support channel estimation for a wideband using signaling via a narrowband, where the narrowband is associated with a bandwidth that is less than a threshold bandwidth, and where the wideband is associated with a bandwidth that is greater than the threshold bandwidth, transmitting a control signal indicating a resource occasion for communication of a FMCW signal via a first BWP of a set of multiple BWPs of the wideband, communicating, via the resource occasion and the first BWP of the set of multiple BWPs, the FMCW signal, and receiving a report indicating one or more second BWPs of the set of multiple BWPs of the wideband based on a channel estimation procedure associated with the set of multiple BWPs of the wideband, where the channel estimation procedure is based on the narrowband FMCW signal.

An apparatus for wireless communications at a network entity is described. The apparatus may include a processor, memory coupled with the processor, and instructions stored in the memory. The instructions may be executable by the processor to cause the apparatus to receive an indication of a capability of a UE to support channel estimation for a wideband using signaling via a narrowband, where the narrowband is associated with a bandwidth that is less than a threshold bandwidth, and where the wideband is associated with a bandwidth that is greater than the threshold bandwidth, transmit a control signal indicating a resource occasion for communication of a FMCW signal via a first BWP of a set of multiple BWPs of the wideband, communicating, via the resource occasion and the first BWP of the set of multiple BWPs, the FMCW signal, and receive a report indicating one or more second BWPs of the set of multiple BWPs of the wideband based on a channel estimation procedure associated with the set of multiple BWPs of the wideband, where the channel estimation procedure is based on the narrowband FMCW signal.

Another apparatus for wireless communications at a network entity is described. The apparatus may include means for receiving an indication of a capability of a UE to support channel estimation for a wideband using signaling via a narrowband, where the narrowband is associated with a bandwidth that is less than a threshold bandwidth, and where the wideband is associated with a bandwidth that is greater than the threshold bandwidth, means for transmitting a control signal indicating a resource occasion for communication of a FMCW signal via a first BWP of a set of multiple BWPs of the wideband, means for communicating, via the resource occasion and the first BWP of the set of multiple BWPs, the FMCW signal, and means for receiving a report indicating one or more second BWPs of the set of multiple BWPs of the wideband based on a channel estimation procedure associated with the set of multiple BWPs of the wideband, where the channel estimation procedure is based on the narrowband FMCW signal.

A non-transitory computer-readable medium storing code for wireless communications at a network entity is described. The code may include instructions executable by a processor to receive an indication of a capability of a UE to support channel estimation for a wideband using signaling via a narrowband, where the narrowband is associated with a bandwidth that is less than a threshold bandwidth, and where the wideband is associated with a bandwidth that is greater than the threshold bandwidth, transmit a control signal indicating a resource occasion for communication of a FMCW signal via a first BWP of a set of multiple BWPs of the wideband, communicating, via the resource occasion and the first BWP of the set of multiple BWPs, the FMCW signal, and receive a report indicating one or more second BWPs of the set of multiple BWPs of the wideband based on a channel estimation procedure associated with the set of multiple BWPs of the wideband, where the channel estimation procedure is based on the narrowband FMCW signal.

In some examples of the method, apparatuses, and non-transitory computer-readable medium described herein, receiving the indication of the capability of the UE may include operations, features, means, or instructions for receiving an indication of one or more time thresholds associated with switching from receiving a first type of signaling to receiving a second type of signaling, switching from receiving the second type of signaling to receiving the first type of signaling, performing the channel estimation procedure, or any combination thereof.

In some examples of the method, apparatuses, and non-transitory computer-readable medium described herein, the first type of signaling may be FMCW signaling and the second type of signaling may be OFDM signaling.

In some examples of the method, apparatuses, and non-transitory computer-readable medium described herein, transmitting the indication of the resource occasion may include operations, features, means, or instructions for transmitting an indication of a start time, a start frequency, a duration, a bandwidth, a slope, or any combination thereof, associated with the FMCW signal, where the resource occasion may be based on the start time, the start frequency, the duration, the bandwidth, the slope, or any combination thereof.

In some examples of the method, apparatuses, and non-transitory computer-readable medium described herein, the duration includes one or more symbol lengths, a portion of a symbol length, one or more slot lengths, a portion of a slot length, a length of a CP, or any combination thereof.

Some examples of the method, apparatuses, and non-transitory computer-readable medium described herein may further include operations, features, means, or instructions for transmitting an indication of one or more resources associated with communicating the report indicating one or more second BWPs, where the report may be received via the one or more resources.

In some examples of the method, apparatuses, and non-transitory computer-readable medium described herein, the control signaling includes the indication of the one or more resources.

In some examples of the method, apparatuses, and non-transitory computer-readable medium described herein, the indication of the one or more resources may be received via a second control signal and the second control signal includes DCI, a MAC-CE, or RRC signaling.

Some examples of the method, apparatuses, and non-transitory computer-readable medium described herein may further include operations, features, means, or instructions for transmitting a second control signal indicating a set of BWP configurations, where the report includes an indication of a first BWP configuration from the set of BWP configurations, and where the first BWP configuration may be associated with the one or more second BWPs.

In some examples of the method, apparatuses, and non-transitory computer-readable medium described herein, the control signal includes DCI, a MAC-CE, or a RRC signal.

In some examples of the method, apparatuses, and non-transitory computer-readable medium described herein, the control signal includes a dynamic indication of the resource occasion or a semi-persistent indication of the resource occasion.

In some examples of the method, apparatuses, and non-transitory computer-readable medium described herein, the FMCW signal may be communicated via unicast, groupcast, broadcast, or multicast.

Some examples of the method, apparatuses, and non-transitory computer-readable medium described herein may further include operations, features, means, or instructions for transmitting a second control signal indicating at least one BWP of the one or more second BWPs based on the report and communicating via the at least one BWP of the one or more second BWPs.

In some examples of the method, apparatuses, and non-transitory computer-readable medium described herein, the first BWP may be of one or more BWPs associated with the narrowband.

### BRIEF DESCRIPTION OF THE DRAWINGS

FIG. 1 illustrates an example of a wireless communications system that supports bandwidth part selection using frequency modulated continuous waveform (FMCW)-based orthogonal frequency division multiplexing (OFDM) channel estimation in accordance with one or more aspects of the present disclosure.

FIG. 2 illustrates an example of a wireless communications system that supports bandwidth part selection using FMCW-based OFDM channel estimation in accordance with one or more aspects of the present disclosure.

FIG. 3 illustrates an example of a wireless communications system that supports bandwidth part selection using FMCW-based OFDM channel estimation in accordance with one or more aspects of the present disclosure.

FIG. 4 illustrates an example of a channel estimation procedure that supports bandwidth part selection using FMCW-based OFDM channel estimation in accordance with one or more aspects of the present disclosure.

FIG. 5 illustrates examples of timing diagrams that supports bandwidth part selection using FMCW-based OFDM channel estimation in accordance with one or more aspects of the present disclosure.

FIG. 6 illustrates an example of a process flow that supports bandwidth part selection using FMCW-based OFDM channel estimation in accordance with one or more aspects of the present disclosure.

FIGS. 7 and 8 illustrate block diagrams of devices that support bandwidth part selection using FMCW-based OFDM channel estimation in accordance with one or more aspects of the present disclosure.

FIG. 9 illustrates a block diagram of a communications manager that supports bandwidth part selection using FMCW-based OFDM channel estimation in accordance with one or more aspects of the present disclosure.

FIG. 10 illustrates a diagram of a system including a device that supports bandwidth part selection using FMCW-based OFDM channel estimation in accordance with one or more aspects of the present disclosure.

FIGS. 11 and 12 illustrate block diagrams of devices that support bandwidth part selection using FMCW-based OFDM channel estimation in accordance with one or more aspects of the present disclosure.

FIG. 13 illustrates a block diagram of a communications manager that supports bandwidth part selection using FMCW-based OFDM channel estimation in accordance with one or more aspects of the present disclosure.

FIG. 14 illustrates a diagram of a system including a device that supports bandwidth part selection using FMCW-based OFDM channel estimation in accordance with one or more aspects of the present disclosure.

FIGS. 15 through 17 illustrate flowcharts showing methods that support bandwidth part selection using FMCW-based OFDM channel estimation in accordance with one or more aspects of the present disclosure.

### DETAILED DESCRIPTION

In some wireless communications systems, a wireless device, such as a user equipment (UE), may estimate (e.g., measure) an orthogonal frequency division multiplexing (OFDM) channel based on one or more received signals to improve reliability and throughput of transmissions and receptions by the wireless device. In some cases, the wireless device may communicate over the OFDM channel via a first bandwidth part (BWP) (e.g., associated with a narrowband), where the first BWP is from a set of BWPs associated with a wideband (e.g., is a subset of a whole bandwidth). In other words, the wireless device may support narrowband baseband processing, and in some cases, other BWPs associated with the wideband (e.g., in the bandwidth) may be allocated for other purposes (e.g., for spectrum allocation or multiplexing for multiple wireless devices). In such cases, the wireless device may measure the OFDM channel (e.g., perform a channel estimation procedure) using one or more signals received via the first BWP but may be unable to measure the OFDM channel in other BWPs from the set of BWPs associated with the wideband due to an inability to receive one or more signals via the other BWPs. As such, the OFDM channel over the first BWP may be associated with lower channel quality metrics than the OFDM channel over another BWP from the set of BWPs associated with the wideband, however, the wireless device may be unaware that the OFDM channel over the other BWP is associated with a higher channel quality due to the inability to measure the OFDM channel over the other BWP. Thus, the wireless device may continue to communicate via the first BWP, which may result in reduced communication performance, among other disadvantages.

Accordingly, techniques described herein may support selection of a BWP for OFDM communications based on frequency modulation continuous wave (FMCW)-based OFDM channel estimation. For example, a UE may transmit an indication of a capability of the UE to support channel estimation for a wideband using signaling via a narrowband (e.g., FMCW-based OFDM channel estimation). In such cases, the narrowband may be associated with a bandwidth that is less than a threshold bandwidth and the wideband may be associated with a bandwidth that is greater than the threshold bandwidth. In other words, the narrowband may be associated with a first BWP from a set of BWPs, where the set of BWPs are associated with the wideband. Additionally, the UE may receive, via the first BWP of the set of BWPs, a control signal indicating a resource occasion for communication of an FMCW signal. Accordingly, the UE may receive, via the resource occasion and the first BWP, the FMCW signal. Additionally, the UE may perform a channel estimation procedure (e.g., FMCW-based OFDM channel estimation procedure) based on samples of a combined FMCW signal (e.g., narrowband signal), where the combined FMCW signal includes a combination of the received FMCW signal (e.g., wideband signal) and a second FMCW signal generated at the UE. In other words, the UE may estimate the OFDM channel over the set of BWPs (e.g., associated with the wideband), such that the UE may select one or more second BWPs from the set of BWPs of the wideband based on the channel estimation procedure and transmit a report indicating the one or more second BWPs.

Aspects of the disclosure are initially described in the context of wireless communications systems. Aspects of the disclosure are then described in the context of a channel estimation procedure, timing diagrams, and a process flow. Aspects of the disclosure are further illustrated by and described with reference to apparatus diagrams, system diagrams, and flowcharts that relate to bandwidth part selection using FMCW-based OFDM channel estimation.

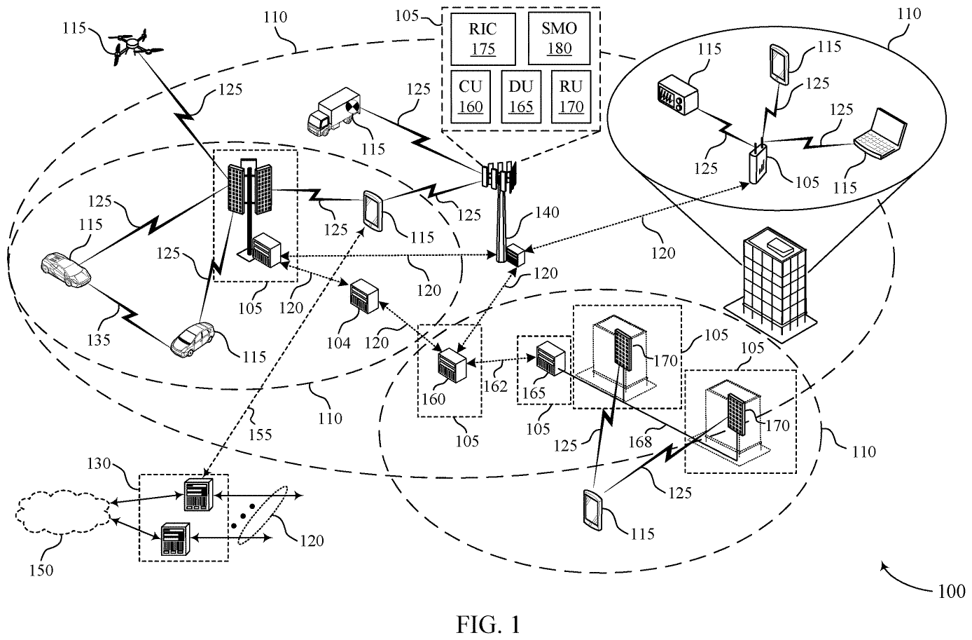

FIG. 1 illustrates an example of a wireless communications system 100 that supports bandwidth part selection using FMCW-based OFDM channel estimation in accordance with one or more aspects of the present disclosure. The wireless communications system 100 may include one or more network entities 105, one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via one or more communication links 125 (e.g., a radio frequency (RF) access link). For example, a network entity 105 may support a coverage area 110 (e.g., a geographic coverage area) over which the UEs 115 and the network entity 105 may establish one or more communication links 125.

The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices, such as other UEs 115 or network entities 105, as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with the core network 130, or with one another, or both. For example, network entities 105 may communicate with the core network 130 via one or more backhaul communication links 120 (e.g., in accordance with an S1, N2, N3, or other interface protocol). In some examples, network entities 105 may communicate with one another via a backhaul communication link 120 (e.g., in accordance with an X2, Xn, or other interface protocol) either directly (e.g., directly between network entities 105) or indirectly (e.g., via a core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication links 120, midhaul communication links 162, or fronthaul communication links 168 may be or include one or more wired links (e.g., an electrical link, an optical fiber link), one or more wireless links (e.g., a radio link, a wireless optical link), among other examples or various combinations thereof. A UE 115 may communicate with the core network 130 via a communication link 155.

One or more of the network entities 105 described herein may include or may be referred to as a base station 140 (e.g., a base transceiver station, a radio base station, an NR base station, an access point, a radio transceiver, a NodeB, an eNodeB (eNB), a next-generation NodeB or a giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within a single network entity 105 (e.g., a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among two or more network entities 105, such as an integrated access backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU) 160, a distributed unit (DU) 165, a radio unit (RU) 170, a RAN Intelligent Controller (RIC) 175 (e.g., a Near-Real Time RIC (Near-RT RIC), a Non-Real Time RIC (Non-RT RIC)), a Service Management and Orchestration (SMO) 180 system, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, and any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3(L 3), layer 2 (L2)) functionality and signaling (e.g., Radio Resource Control (RRC), service data adaption protocol (SDAP), Packet Data Convergence Protocol (PDCP)). The CU 160 may be connected to one or more DUs 165 or RUs 170, and the one or more DUs 165 or RUs 170 may host lower protocol layers, such as layer 1(L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or more RUs 170). In some cases, a functional split between a CU 160 and a DU 165, or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to one or more DUs 165 via a midhaul communication link 162 (e.g., F1, F1-c, F1-u), and a DU 165 may be connected to one or more RUs 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities 105 that are in communication via such communication links.

In wireless communications systems (e.g., wireless communications system 100), infrastructure and spectral resources for radio access may support wireless backhaul link capabilities to supplement wired backhaul connections, providing an IAB network architecture (e.g., to a core network 130). In some cases, in an IAB network, one or more network entities 105 (e.g., IAB nodes 104) may be partially controlled by each other. One or more IAB nodes 104 may be referred to as a donor entity or an IAB donor. One or more DUs 165 or one or more RUs 170 may be partially controlled by one or more CUs 160 associated with a donor network entity 105 (e.g., a donor base station 140). The one or more donor network entities 105 (e.g., IAB donors) may be in communication with one or more additional network entities 105 (e.g., IAB nodes 104) via supported access and backhaul links (e.g., backhaul communication links 120). IAB nodes 104 may include an IAB mobile termination (IAB-MT) controlled (e.g., scheduled) by DUs 165 of a coupled IAB donor. An IAB-MT may include an independent set of antennas for relay of communications with UEs 115, or may share the same antennas (e.g., of an RU 170) of an IAB node 104 used for access via the DU 165 of the IAB node 104 (e.g., referred to as virtual IAB-MT (VIAB-MT)). In some examples, the IAB nodes 104 may include DUs 165 that support communication links with additional entities (e.g., IAB nodes 104, UEs 115) within the relay chain or configuration of the access network (e.g., downstream). In such cases, one or more components of the disaggregated RAN architecture (e.g., one or more IAB nodes 104 or components of IAB nodes 104) may be configured to operate according to the techniques described herein.

In the case of the techniques described herein applied in the context of a disaggregated RAN architecture, one or more components of the disaggregated RAN architecture may be configured to support bandwidth part selection using FMCW-based OFDM channel estimation as described herein. For example, some operations described as being performed by a UE 115 or a network entity 105 (e.g., a base station 140) may additionally, or alternatively, be performed by one or more components of the disaggregated RAN architecture (e.g., IAB nodes 104, DUs 165, CUs 160, RUs 170, RIC 175, SMO 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IOT) device, an Internet of Everything (IoE) device, or a machine type communications (MTC) device, among other examples, which may be implemented in various objects such as appliances, or vehicles, meters, among other examples.

The UEs 115 described herein may be able to communicate with various types of devices, such as other UEs 115 that may sometimes act as relays as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via one or more communication links 125 (e.g., an access link) using resources associated with one or more carriers. The term “carrier” may refer to a set of RF spectrum resources having a defined physical layer structure for supporting the communication links 125. For example, a carrier used for a communication link 125 may include a portion of a RF spectrum band (e.g., a bandwidth part (BWP)) that is operated according to one or more physical layer channels for a given radio access technology (e.g., LTE, LTE-A, LTE-A Pro, NR). Each physical layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities 105).

In some examples, such as in a carrier aggregation configuration, a carrier may also have acquisition signaling or control signaling that coordinates operations for other carriers. A carrier may be associated with a frequency channel (e.g., an evolved universal mobile telecommunication system terrestrial radio access (E-UTRA) absolute RF channel number (EARFCN)) and may be identified according to a channel raster for discovery by the UEs 115. A carrier may be operated in a standalone mode, in which case initial acquisition and connection may be conducted by the UEs 115 via the carrier, or the carrier may be operated in a non-standalone mode, in which case a connection is anchored using a different carrier (e.g., of the same or a different radio access technology).

The communication links 125 shown in the wireless communications system 100 may include downlink transmissions (e.g., forward link transmissions) from a network entity 105 to a UE 115, uplink transmissions (e.g., return link transmissions) from a UE 115 to a network entity 105, or both, among other configurations of transmissions. Carriers may carry downlink or uplink communications (e.g., in an FDD mode) or may be configured to carry downlink and uplink communications (e.g., in a TDD mode).

A carrier may be associated with a particular bandwidth of the RF spectrum and, in some examples, the carrier bandwidth may be referred to as a “system bandwidth” of the carrier or the wireless communications system 100. For example, the carrier bandwidth may be one of a set of bandwidths for carriers of a particular radio access technology (e.g., 1.4, 3, 5, 10, 15, 20, 40, or 80 megahertz (MHz)). Devices of the wireless communications system 100 (e.g., the network entities 105, the UEs 115, or both) may have hardware configurations that support communications using a particular carrier bandwidth or may be configurable to support communications using one of a set of carrier bandwidths. In some examples, the wireless communications system 100 may include network entities 105 or UEs 115 that support concurrent communications using carriers associated with multiple carrier bandwidths. In some examples, each served UE 115 may be configured for operating using portions (e.g., a sub-band, a BWP) or all of a carrier bandwidth.

Signal waveforms transmitted via a carrier may be made up of multiple subcarriers (e.g., using multi-carrier modulation (MCM) techniques such as OFDM or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

One or more numerologies for a carrier may be supported, and a numerology may include a subcarrier spacing (Δf) and a cyclic prefix. A carrier may be divided into one or more BWPs having the same or different numerologies. In some examples, a UE 115 may be configured with multiple BWPs. In some examples, a single BWP for a carrier may be active at a given time and communications for the UE 115 may be restricted to one or more active BWPs.

The time intervals for the network entities 105 or the UEs 115 may be expressed in multiples of a basic time unit which may, for example, refer to a sampling period of Tₛ=1/(Δfₘₐₓ·N_{f}) seconds, for which Δfₘₐₓ may represent a supported subcarrier spacing, and N_{f} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (sTTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115.

In some examples, a network entity 105 (e.g., a base station 140, an RU 170) may be movable and therefore provide communication coverage for a moving coverage area 110. In some examples, different coverage areas 110 associated with different technologies may overlap, but the different coverage areas 110 may be supported by the same network entity 105. In some other examples, the overlapping coverage areas 110 associated with different technologies may be supported by different network entities 105. The wireless communications system 100 may include, for example, a heterogeneous network in which different types of the network entities 105 provide coverage for various coverage areas 110 using the same or different radio access technologies.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs 115 via a device-to-device (D2D) communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to each of the other UEs 115 in the group. In some examples, a network entity 105 may facilitate the scheduling of resources for D2D communications. In some other examples, D2D communications may be carried out between the UEs 115 without an involvement of a network entity 105.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than 100 kilometers) compared to communications using the smaller frequencies and longer waves of the high frequency (HF) or very high frequency (VHF) portion of the spectrum below 300 MHZ.

The wireless communications system 100 may utilize both licensed and unlicensed RF spectrum bands. For example, the wireless communications system 100 may employ License Assisted Access (LAA), LTE-Unlicensed (LTE-U) radio access technology, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device.

The adjustments associated with each of the antenna elements may be defined by a beamforming weight set associated with a particular orientation (e.g., with respect to the antenna array of the transmitting device or receiving device, or with respect to some other orientation).

The wireless communications system 100 may support selection of a BWP for OFDM communications based on FMCW-based OFDM channel estimation. For example, a UE 115 may transmit an indication of a capability of the UE 115 to support channel estimation for a wideband using signaling via a narrowband (e.g., FMCW-based OFDM channel estimation). In other words, the narrowband may be associated with a first BWP from a set of BWPs, where the set of BWPs are associated with the wideband. Additionally, the UE 115 may receive a control signal indicating a resource occasion for communication of an FMCW signal via the first BWP of the set of BWPs. Accordingly, the UE 115 may receive, via the resource occasion and the first BWP, the FMCW signal and perform a channel estimation procedure based on samples of a combined FMW (e.g., narrowband signal), where the combined FMCW signal includes a combination of the received FMCW signal (e.g., wideband signal) and a second FMCW signal generated at the UE 115. In other words, the UE 115 may estimate the OFDM channel over the set of BWPs (e.g., associated with the wideband), such that the UE 115 may select one or more second BWPs from the set of BWPs of the wideband based on the channel estimation procedure and transmit a report indicating the one or more second BWPs.

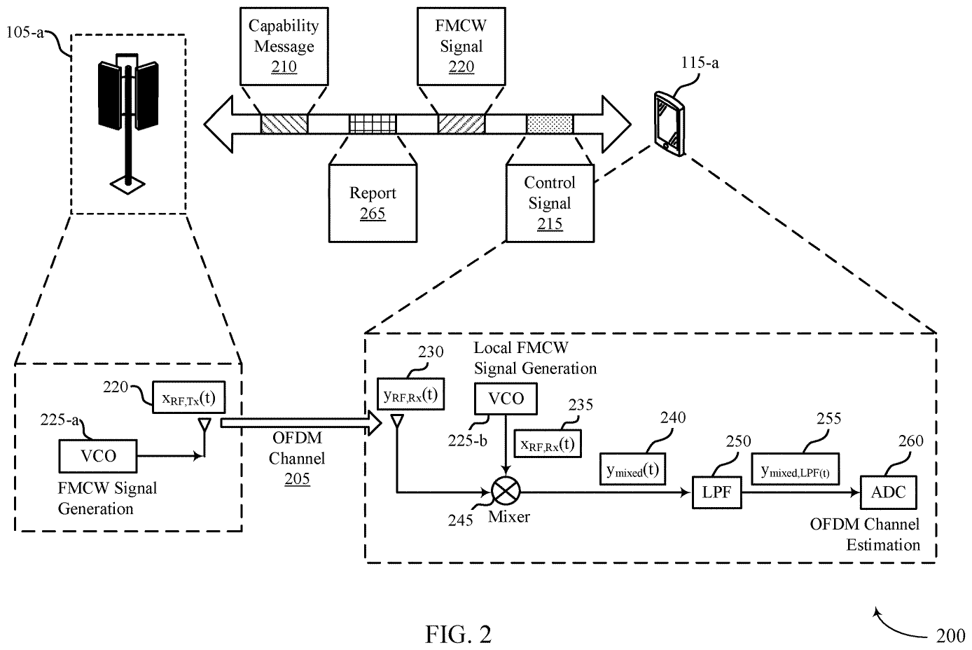

FIG. 2 illustrates an example of a wireless communications system 200 that supports bandwidth part selection using FMCW-based OFDM channel estimation in accordance with one or more aspects of the present disclosure. In some examples, the wireless communications system 200 may implement or be implemented by aspects of the wireless communications system 100. For example, the wireless communications system 200 may include on or more network entities 105 (e.g., network entity 105-a) and one or more UEs 115 (e.g., UE 115-a), which may be examples of the corresponding devices as described with reference to FIG. 1. In some examples, a transmitting device, such as the network entity 105-a, and a receiving device, such as the UE 115-a, may exchange an FMCW signal 220 via an OFDM channel 205, such that the FMCW signal 220 may be used to facilitate channel estimation of the OFDM channel 205 by the UE 115-a.

In some cases, the UE 115-a and the network entity 105-a may establish a connection for wireless communications via the OFDM channel 205 and the network entity 105-a may generate an OFDM signal for transmission to the UE 115-a via the OFDM channel 205. That is, the network entity 105-a may generate a signal associated with an OFDM waveform. In some cases, the UE 115-a may communicate (e.g., with the network entity 105-a) over the OFDM channel 205 via a first BWP, where the first BWP is associated with a narrowband (e.g., the first BWP of the narrowband). That is, the first BWP associated with the narrowband may be from a set of BWPs (e.g., multiple BWPs) associated with a wideband (e.g., the narrowband may be a portion of or a subset of the wideband). In other words, the narrowband may be associated with a bandwidth that is less than a threshold bandwidth and the wideband may be associated with a bandwidth that is greater than the threshold bandwidth (e.g., the first BWP, or narrowband, may be a subset of a whole bandwidth, or wideband). As an illustrative example (e.g., for FR1), a bandwidth (e.g., maximum bandwidth) may be 100 MHz such that the wideband is 100 MHz while the narrowband may be less than 100 MHz (e.g., a subset of the wideband). In another illustrative example (e.g., FR2), a bandwidth (e.g., maximum bandwidth) may be 400 MHz such that the wideband is 400 MHz while the narrowband may be less than 400 MHz. In some examples, the UE 115-a may communicate via the first BWP based on the UE 115-a supporting narrowband baseband processing (e.g., the UE 115-a may be a low-tier UE 115-a, such as a Reduced Capability (RedCap) UE 115-a), or other BWPs associated with the wideband (e.g., in the bandwidth) may be allocated for other purposes (e.g., for spectrum allocation or frequency multiplexing for multiple wireless devices).

In some cases, the UE 115-a may estimate (e.g., measure) the OFDM channel 205 (e.g., perform an OFDM channel estimation procedure) based on one or more received signals to improve reliability and throughput of transmissions and receptions by the UE 115-a. However, the UE 115-a may be unable to measure the OFDM channel 205 over other BWPs from the set of BWPs associated with the wideband (e.g., other BWPs that fall outside of the first BWP) due to the UE 115-a communicating via the first BWP (e.g., being configured with the first BWP, being a narrowband UE 115-a). That is, the UE 115-a may measure the OFDM channel 205 based on one or more signals received via the first BWP and may be unable to measure the OFDM channel 205 over other BWPs due to an inability to receive signals over the OFDM channel via the other BWP. In some examples, the OFDM channel 205 in the first BWP may be associated with lower channel quality than the OFDM channel 205 in another BWP from the set of BWPs associated with the wideband. In other words, transmissions communicated (e.g., by the UE 115-a, the network entity 105-a, or both) over the OFDM channel 205 via the first BWP may be associated with reduced communication performance (e.g., increased latency, increased interference, among other disadvantages) compared to transmissions communicated over the OFDM channel 205 via the other BWP. As such, the UE 115-a may be unaware that other BWP may be associated with improved communication performance due to the inability to measure the OFDM channel 205 over the other BWP.

For example, the UE 115-a may receive control signaling indicating (e.g., configuring the UE 115-a with) a first BWP (e.g., configured BWP) spanning (e.g., associated with) a frequency range from a first resource element (RE) to a second RE (e.g., RE-800 to RE-1000) for the UE 115-a to use to communicate over the OFDM channel 205. However, a second BWP (e.g., of the UE 115-a) spanning a frequency range from a third RE to a fourth RE (e.g., RE-200 to RE-400) may be associated with higher channel quality, lower latency, or improved communication reliability, among other advantages (e.g., may be more suitable or have a higher likelihood of successful wireless communications) as compared to the first BWP. That is, the first BWP and the second BWP may be associated with a same bandwidth (e.g., the bandwidth of the first BWP may be equivalent to the bandwidth of the second BWP). However, the UE 115-a may be unable to measure the OFDM channel 205 over the second BWP (e.g., using an OFDM communication scheme). Thus, the UE 115-a may continue to communicate via the first BWP, which may result in reduced communication performance, among other disadvantages.

Accordingly, the techniques described herein may support FMCW-based OFDM channel estimation. For example, the UE 115-a may transmit, to the network entity 105-a, a capability message 210 indicating a capability of the UE 115-a to support FMCW-based OFDM channel estimation. That is, the capability message 210 may indicate a capability of the UE 115-a to perform channel estimation of a wideband using narrowband signaling. In other words, the capability message 210 may indicate a capability of the UE 115-a to receive signaling over the OFDM channel 205 via a first BWP (e.g., associated with a narrowband) of a set of BWPs associated with a wideband and to estimate the OFDM channel 205 over the set of BWPs of the wideband based on the signaling received via the first BWP.

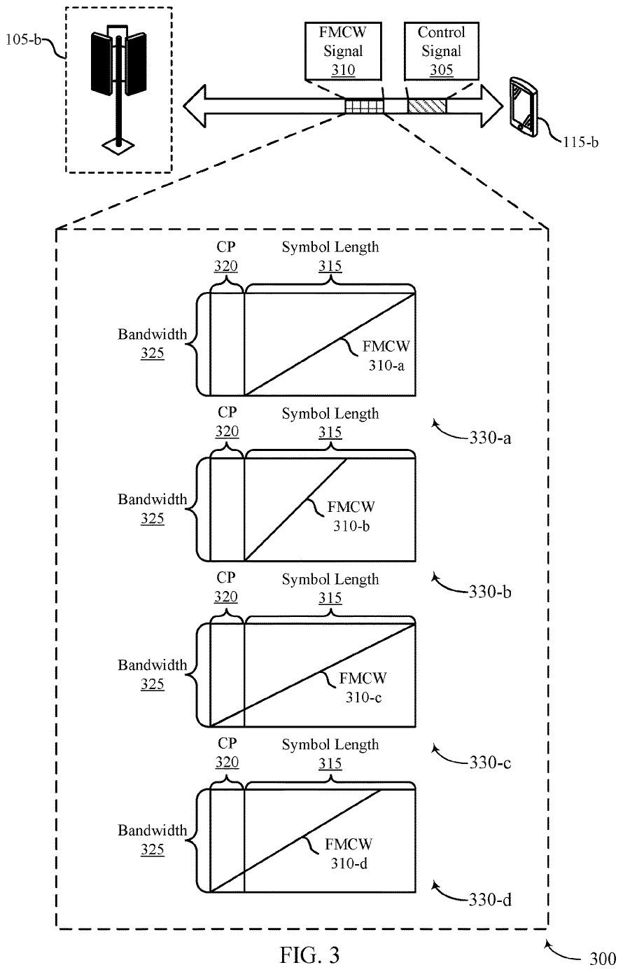

In some examples, the network entity 105-a may transmit, via the first BWP of the OFDM channel 205, a control signal 215 indicating a resource occasion associated with an FMCW signal 220, as described with reference to FIG. 3. That is, the network entity 105-a may transmit a signal associated with an FMCW waveform (e.g., FMCW signal 220) via the indicated resource occasion. As such, the UE 115-a may receive the FMCW signal 220 via the resource occasion and via the first BWP of the OFDM channel 205 and may perform an FMCW-based OFDM channel estimation procedure.

For example, the network entity 105-a may generate the FMCW signal 220 (e.g., x_{RF,Tx}(t)) in an analog domain using a voltage controlled oscillator (VCO) 225-a. The network entity 105-a may transmit (e.g., unicast, groupcast, multicast, or broadcast) the FMCW signal 220 via the OFDM channel 205 using at least one antenna element at the network entity 105-a. In such cases, the FMCW signal 220 may be a time-domain signal (e.g., a function of time (t)). Additionally, or alternatively, the FMCW signal 220 may be associated with a semi-persistent transmission or a dynamic transmission. As illustrated in FIG. 3, the FMCW signal 220 may be associated with a waveform signal transmitted via a symbol of the OFDM channel 205 in the time domain and a bandwidth (e.g., a set of BWPs) of the OFDM channel 205 in the frequency domain (e.g., via the first BWP). That is, the FMCW signal 220 may be associated with a waveform signal transmitted via a full bandwidth of the OFDM channel 205 in the frequency domain (e.g., the FMCW signal 220 may be a wideband signal).

The UE 115-a may receive a radio frequency FMCW signal 230 (e.g., YRF, Tx(t)) via the OFDM channel 205 in response to the FMCW signal 220 transmitted by the network entity 105-a. Additionally, as described herein, the UE 115-a may generate an FMCW signal 235 (e.g., x_{RF, Rx}(t)) at the UE 115-a. The FMCW signal 235 generated at the UE 115-a may be referred to as a second FMCW signal or a local FMCW signal. The UE 115-a may generate the FMCW signal 235 in the analog domain using a VCO 225-b at the UE 115-a. The UE 115-a may generate the FMCW signal 235 at the same time as or after receiving the FMCW signal 230.

In some cases, the UE 115-a may generate the FMCW signal 235 based on a set of FMCW parameters associated with the FMCW signal 220 transmitted by the network entity 105-a. The set of FMCW parameters may include, for example, a starting frequency of the FMCW signal 220, a slope of the FMCW signal 220, an initial phase of a network entity 105-a, or any combination thereof, as described with reference to FIG. 3. That is, the FMCW signal 235 generated by the UE 115-a may have a same starting frequency and slope as the FMCW signal 220 generated by the network entity 105-a.

The FMCW signal 220 transmitted by the network entity 105-a and the FMCW signal 235 generated at the UE 115-a may have similar FMCW structures. For example, both signals may be wideband signals (e.g., may span the set of BWPs or a full bandwidth of the OFDM channel 205), may span a duration of a symbol in the OFDM channel 205, may be associated with a same starting frequency, and may be associated with a same slope. In some examples, the FMCW signal 220 transmitted by the network entity 105-a may be a real signal. For example, the FMCW signal 220 may include a single stream. The FMCW signal 235 generated by the UE 115-a may include two streams (e.g., a sinusoidal stream and a cosine stream) for channel estimation. That is, the exponential function in the FMCW signal 235 generated by the UE 115-a may be designed for channel estimation. In some examples, the UE 115-a may be configured with a function for generating the FMCW signal 235 for channel estimation, or the UE 115-a may receive a control message that indicates the function for generating the FMCW signal 235 for channel estimation.

After generating the FMCW signal 235 configured for channel estimation, the UE 115-a may generate a combined FMCW signal 240 (e.g., y_{mixed}(t)). To generate the combined FMCW signal 240, the UE 115-a may combine the FMCW signal 230 received at the UE 115-a with the locally generated FMCW signal 235 using a mixer 245. The mixer 245 may represent an example of one or more components (e.g., hardware, software, or both) of the UE 115-a that are configured to combine two or more time-domain FMCW signals. In some examples, the combining may include multiplying the FMCW signals (e.g., y_{mixed}(t)=y_{RF,Rx}(t)x_{RF,Rx}(t)).

The UE 115-a may filter the combined FMCW signal 240 using an low pass filter (LPF) 250 at the UE 115-a. The LPF 250 may generate a combined and filtered FMCW signal 255 (e.g., y_{mixed,LPF}(t)). The LPF 250 may represent an example of a component of the UE 115-a that is configured to filter signals, or a function supported by the UE 115-a, or both. For example, the UE 115-a may apply an LPF function to the combined FMCW signal 240 (e.g., y_{mixed,LPF}(t)=LPF[y_{RF,Rx}(t)x_{RF,UE}(t)]).

After combining and filtering the FMCW signals, the UE 115-a may perform frequency domain OFDM channel estimation using time-domain signal processing (e.g., FMCW-based OFDM channel estimation) based on sampling the combined and filtered FMCW signal 255. The UE 115-a may use an ADC 260 to sample the combined and filtered FMCW signal 255 in the time domain. A sampling rate used to sample the combined and filtered FMCW signal 255 may be based on one or more parameters associated with the OFDM channel 205. For example, the sampling rate may be based on a frequency range of one or more subbands in the OFDM channel 205. The subband frequency range may represent a granularity at which the UE 115-a can estimate the OFDM channel 205 in the frequency domain.

The UE 115-a may thereby estimate the frequency domain OFDM channel 205 using time domain signal processing and with a granularity based on the FMCW signal 230 received at the UE 115-a and the FMCW signal 235 generated by the UE 115-a. The described FMCW-based OFDM channel estimation techniques may be performed by the UE 115-a in the time domain using time domain signal processing.

That is, the UE 115-a may refrain from applying Fast Fourier Transform (FFT) or other frequency transforms when using the FMCW signals to estimate the frequency domain OFDM channel 205. By performing the OFDM channel estimation in the time domain, the UE 115-a may reduce processing complexity, latency, and power consumption as compared with other OFDM channel estimation techniques performed at least partially in the frequency domain (e.g., using FFT). Additionally, or alternatively, the UE 115-a may estimate the frequency domain OFDM channel 205 using narrowband radio frequency processing. That is, the FMCW signal 230 received at the UE 115-a may be a wideband signal in the radio frequency, and after the LPF, the combined and filtered FMCW signal 255 may be a narrowband signal for baseband processing.

As such, the UE 115-a may select one or more second BWPs (e.g., BWPs which have a higher channel quality than a BWP configured for the UE 115-a) from the set of BWPs (e.g., of the wideband) associated with the OFDM channel 205 based on the FMCW-based OFDM channel estimation and may transmit, to the network entity 105-a, an indication of the one or more second BWPs via a report 265. In some examples, the network entity 105-a may indicate (e.g., dynamically trigger) for the UE 115-a to transmit the report 265. In such cases, the network entity 105-a may indicate one or more resources for transmission of the report 265. In some examples (e.g., the network entity 105-a transmits the FMCW signal 220 dynamically), the network entity 105-a may include the indication of the one or more resources (e.g., time domain and frequency domain resources) for transmitting the report 265 in the control signal 215 indicating the resource occasion associated with the FMCW signal 220. Additionally, or alternatively, the network entity 105-a may transmit the indication of the one or more resources for transmission of the report 265 using a second control signal 215 (e.g., downlink control information (DCI), MAC-control element (MAC-CE), or RRC signaling). In some other examples (e.g., the network entity 105-a transmits the FMCW signal 220 semi persistently), the control signal 215 may include a semi-persistent configuration associated with the one or more resource occasions, such that the semi-persistent configuration further includes the indication of the one or more resources for transmitting the report 265. Alternatively, the network entity 105-a may indicate a set of resources (e.g., resource set) for transmitting the report 265 in the semi-persistent configuration and may transmit a second control signal 215 (e.g., DCI, MAC-CE, or RRC signaling) indicating an index associated with one or more resources from the set of resources, where the one or more resources are associated with transmission of the report 265.

As such, the network entity 105-a may receive the report 265 and may configure the UE 115-a to communicate via at least a subset of the one or more second BWPs. In other words, the network entity 105-a may select the at least subset of the one or more second BWPs from the one or more second BWPs indicate via the report 265 and transmit, to the UE 115-a, an additional control signal 215 indicating the at least a subset of the one or more second BWPs. Accordingly, the UE 115-a may switch to the at least a subset of the one or more second BWPs (e.g., one or more preferred BWPs)

FIG. 3 illustrates an example of a wireless communications system 300 that supports bandwidth part selection using FMCW-based OFDM channel estimation in accordance with one or more aspects of the present disclosure. In some examples, the wireless communications system 300 may implement or be implemented by aspects of the wireless communications system 100 and the wireless communications system 200. For example, the wireless communications system 300 may include on or more network entities 105 (e.g., network entity 105-b) and one or more UEs 115 (e.g., UE 115-b), which may be examples of the corresponding devices as described with reference to FIG. 1. In some examples, the network entity 105-b may transmit, to the UE 115-b, an FMCW signal 310 via an OFDM channel, such that the FMCW signal 310 may be used to facilitate channel estimation of the OFDM channel by the UE 115-b.

As described with reference to FIG. 2, the network entity 105-b may transmit (e.g., dynamically or semi-persistently), to a UE 115-b, a control signal 305 (e.g., DCI, MAC-CE, or RRC signaling) indicating one or more resource occasions (e.g., time-domain resources) associated with the FMCW signal 310. For example, the indication of the one or more resource occasions (e.g., time-domain resource occasions) may include a start time of the FMCW signal 310, a duration of the FMCW signal 310, or both. For example, the duration may be one or more symbol lengths 315, a portion of a symbol length 315, one or more slot lengths, a portion of a slot length, or a like thereof. Additionally, the duration may include a length of a CP 320 or exclude a length of the CP 320. Additionally, the control signal 305 may indicate a start frequency of the FMCW signal 310, a bandwidth 325 of the FMCW signal 310, a slope of the FMCW signal 310, or any combination thereof. In some examples, the control signal 305 may be DCI, MAC-CE, or RRC signaling.

As such, as illustrated in timing diagrams 325, the FMCW signal 310 may be associated with a waveform signal transmitted via at least a portion of a symbol (e.g., a symbol length 315) in the time domain and a bandwidth 325 in the frequency domain.

For example, in timing diagram 330-a, an FMCW signal 310-a may span (e.g., last) a duration that includes the symbol length 315 (e.g., an entire symbol length 315) and excludes the length of the CP 320. In a timing diagram 330-b, an FMCW signal 310-b may span a duration that includes a portion of the symbol length 315 and excludes the length of the CP 320. In a timing diagram 330-c, an FMCW signal 310-c may span a duration that includes the symbol length 315 and includes the length of the CP 320. In a timing diagram 330-d, an FMCW signal 310-d may span a duration that includes a portion of the symbol length 315 and includes the length of the CP 320. Additionally, in each timing diagram 330, the FMCW signals 310 may be associated with a start frequency and the bandwidth 325 (e.g., indicated via the control signal 305). In some examples (e.g., for wideband channel estimation), the bandwidth 325 may be an entire bandwidth associated with the OFDM channel.

Accordingly, as described with reference to FIG. 2, the UE 115-a may receive the FMCW signal 310 via the one or more resource occasions indicated via the control signal 305. Additionally, as described with reference to FIG. 2, the UE 115-a may generate an FMCW signal 310 (e.g., a generated FMCW signal) based on a set of FMCW parameters associated with the received FMCW signal 310. As described previously, the set of FMCW parameters may include, for example, the starting frequency of the received FMCW signal 310, the bandwidth of the received FMCW signal 310, the slope of the received FMCW signal 310, or both. In such cases, the UE 115-a may determine the set of FMCW parameters based on the one or more resource occasions indicated via the control signal 305.

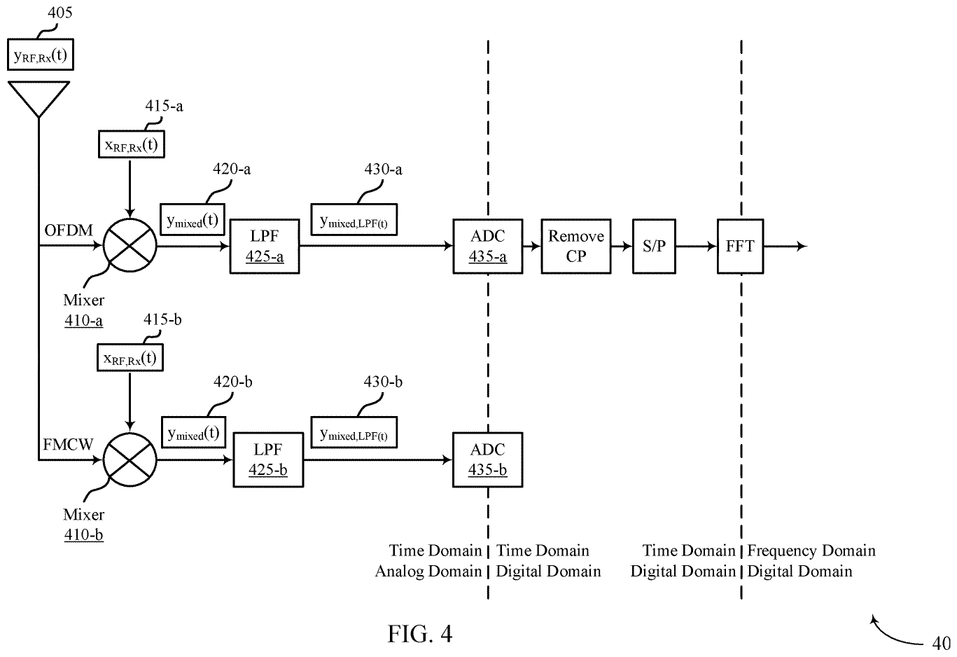

FIG. 4 illustrates an example of a channel estimation procedure 400 that supports bandwidth part selection using FMCW-based OFDM channel estimation in accordance with one or more aspects of the present disclosure. In some examples, the channel estimation procedure 400 may implement or be implemented by aspects of the wireless communications system 100, the wireless communications system 200, and the wireless communications system 300. For example, the channel estimation procedure 400 may be implemented by one or more network entities 105 or one or more UEs 115, which may be examples of the corresponding devices as described with reference to FIG. 1. In some examples, a network entity may transmit, to a UE 115, an FMCW signal 405 via an OFDM channel, such that the FMCW signal 405 may be used to facilitate channel estimation of the OFDM channel by the UE 115.

As described with reference to FIG. 2, a UE 115 may receive a signal 405 (e.g., y_{RF,Tx}(t)) via an OFDM channel and, in some examples, the signal 405 may be an OFDM signal 405 (e.g., an analog time domain OFDM signal 405). Additionally, the UE 115 may generate a signal 415-a (e.g., x_{RF,Rx}(t)) at the UE 115, which may be a local carrier frequency signal 415-a (e.g., e^{2πf}^{_{c}}^{t}), in the analog domain. Further, the UE 115 may generate a combined OFDM signal 420-a (e.g., y_{mixed}(t)). To generate the combined OFDM signal 420-a, the UE 115 may combine the received OFDM signal 405 with the local carrier frequency signal 415-a using a mixer 410-a. The mixer 410-a may represent an example of one or more components (e.g., hardware, software, or both) of the UE 115 that are configured to combine two or more time-domain signals. In some examples, the combining may include multiplying the signals (e.g., y_{mixed}(t)=Y_{RF,Rx}(t)x_{RF,Rx}(t)).

The UE 115 may filter the combined OFDM signal 420-a using an LPF 425-a at the UE 115. The LPF 425-a may generate a combined and filtered OFDM signal 430-a (e.g., y_{mixed,LPF}(t)), which may be referred to as a baseband OFDM signal. The LPF 425-a may represent an example of a component of the UE 115 that is configured to filter signals, or a function supported by the UE 115, or both. For example, the UE 115 may apply an LPF function to the combined OFDM signal 420-a (e.g., y_{mixed,LPF}(t)=LPF[y_{RF,Rx}(t)x_{RF,UE}(t)]).

After combining and filtering the OFDM signals, the UE 115 may perform OFDM baseband signal processing based on sampling the combined and filtered OFDM signal 430-a. The UE 115 may use an ADC 435-a to convert the combined and filtered OFDM signal 430-a to a digital domain and sample the combined and filtered OFDM signal 430-a in the time domain. The UE 115 may perform CP removal to remove the CP(s) from the digital time domain OFDM signal after using the ADC 435-a. After removing CPs, the UE 115 may change the digital time domain OFDM signal from serial to parallel and may perform FFT on the digital time domain OFDM signal. The FFT may convert the time domain OFDM signal to a frequency domain OFDM signal. That is, the FFT may produce a set of frequency domain OFDM signals. As such, the UE 115 may use the set of frequency domain signals produced by the FFT to process OFDM signal 405.

In some other examples, the UE 115 may receive the signal 405 (e.g., analog signal 405) via an OFDM channel, and the signal 405 may be an FMCW signal 405 (e.g., an analog time domain FMCW signal 405). Additionally, the UE 115 may generate a signal 415-b (e.g., x_{RF,Rx}(t)) at the UE 115, which may be a local FMCW signal 415-b, in the analog domain. Further, the UE 115 may generate a combined FMCW signal 420-b (e.g., y_{mixed}(t)). To generate the combined FMCW signal 420-b, the UE 115 may combine the received FMCW signal 405 with the local FMCW signal 415-b using a mixer 410-b. The mixer 410-b may represent an example of one or more components (e.g., hardware, software, or both) of the UE 115 that are configured to combine two or more time-domain FMCW signals. In some examples, the combining may include multiplying the FMCW signals (e.g., y_{mixed}(t)=Y_{RF,Rx}(t)x_{RF,Rx}(t)).

The UE 115 may filter the combined FMCW signal 420-b using an LPF 425-b at the UE 115. The LPF 425-b may generate a combined and filtered FMCW signal 430-b (e.g., y_{mixed,LPF}(t)). The LPF 425-b may represent an example of a component of the UE 115 that is configured to filter signals, or a function supported by the UE 115, or both. For example, the UE 115 may apply an LPF function to the combined FMCW signal 420-b (e.g., y_{mixed,LPF}(t)=LPF[y_{RF,Rx}(t)x_{RF,UE}(t)]). The UE 115 may use an ADC 435-b to convert the combined and filtered FMCW signal 430-b to a digital domain and sample the combined and filtered OFDM signal 430-b in the time domain. As such, the UE 115 may estimate the frequency domain OFDM channel based on the samples the combined and filtered OFDM signal 430-b in the time domain.

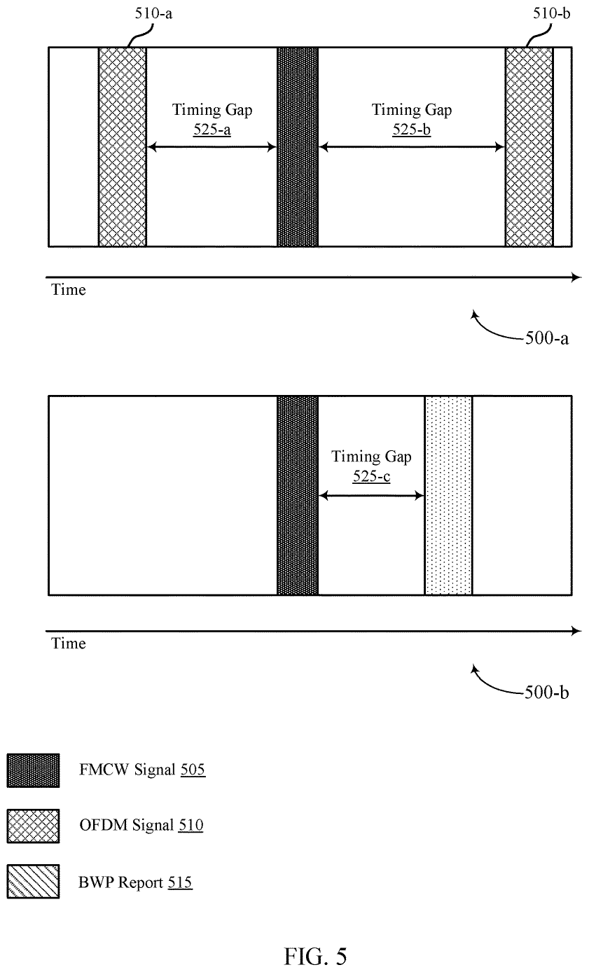

As such, the UE 115 may support OFDM signal processing and FMCW signal processing. Additionally, the UE 115 may support a capability to switch between the OFDM signal processing (e.g., OFDM reception) and the FMCW signal processing (e.g., FMCW reception). In such cases, the UE 115 may transmit, to a network entity 105, an indication of a capability of the UE 115 to support FMCW-based OFDM channel estimation (e.g., channel estimation for a wideband using signaling via a narrowband), as described with reference to FIG. 5. In some cases, the indication of the capability of the UE 115 may include one or more time threshold associated with switching between OFDM signal processing (e.g., legacy OFDM reception) and FMCW signal processing (e.g., FMCW reception).

FIG. 5 illustrates examples of timing diagrams 500 (e.g., a timing diagram 500-a and a timing diagram 500-b) that supports bandwidth part selection using FMCW-based OFDM channel estimation in accordance with one or more aspects of the present disclosure. In some examples, the timing diagrams 500 may implement or be implemented by aspects of the wireless communications system 100, the wireless communications system 200, the wireless communications system 300, and the channel estimation procedure 400. For example, the timing diagrams 500 may be implemented by one or more network entities 105 or one or more UEs 115, which may be examples of the corresponding devices as described with reference to FIG. 1. In some examples, a UE 115 may support a capability to switch between OFDM signal processing and FMCW signal processing to support FMCW-based OFDM channel estimation.

In some examples, the UE 115 may support FMCW-based OFDM channel estimation. In such cases, the UE 115 may switch between FMCW signal processing (e.g., FMCW reception) and OFDM signal processing (e.g., OFDM reception). That is, as depicted in the timing diagram 500-a, the UE 115 may receive an OFDM signal 510-a at a first time and an FMCW signal 505 at a second time. As such, a timing gap 525-a may exist between the first time (e.g., transmission of the OFDM signal 510-a) and the second time (e.g., transmission of the FMCW signal 505). In other words, the timing gap 525-a may be greater than or equal to a first time threshold (e.g., first minimum time threshold, TG1) that is based on a capability of the UE 115 to switch from OFDM signal processing (e.g., legacy OFDM reception) to FMCW signal processing (e.g., FMCW reception). That is, the first time threshold may be a duration (e.g., minimum duration) associated with the UE 115 switching from OFDM signal processing to FMCW signal processing.

Additionally, the UE 115 may receive the FMCW signal 505 at the second time and receive an OFDM signal 510-b at a third time. As such a timing gap 525-b may exist between the second time (e.g., transmission of the FMCW signal 505) and the third time (e.g., transmission of the OFDM signal 510-b). In other words, the timing gap 525-b may be greater than or equal to a second time threshold (e.g., second minimum time threshold, TG2) that is based on a capability of the UE 115 to switch from FMCW signal processing (e.g., FMCW reception) to OFDM signal processing (e.g., legacy OFDM reception). That is, the second time threshold may be a duration (e.g., minimum duration) associated with the UE 115 switching from FMCW signal processing to OFDM signal processing.

Additionally, or alternatively, as depicted in the timing diagram 500-b, the UE 115 may receive an FMCW signal 505, perform FMCW-based OFDM channel estimation, and transmit a BWP report 515 indicating one or more BWPs (e.g., preferred BWPs) based on the FMCW-based OFDM channel estimation. That is, the UE 115 may receive the FMCW signal 505 at a fourth time and transmit the BWP report 515 at a fifth time. As such, a timing gap 525-c may exist between the fourth time (e.g., reception of the FMCW signal 505) and the fifth time (e.g., transmission of the BWP report 515). In other words, the timing gap 525-c may be greater than or equal to a third time threshold (e.g., third minimum time threshold, TG3) that is based on a capability of the UE 115 to perform FMCW-based OFDM channel estimation. That is, the third time threshold may be a duration associated with the UE 115 performing FMCW-based OFDM channel estimation.

In some examples, the UE 115 may transmit, to a network entity 105, an indication of the capability of the UE 115 to support FMCW-based OFDM channel estimation (e.g., channel estimation for a wideband using signaling via a narrowband). For example, the UE 115 may transmit, to the network entity 105, a capability message indicating the first time threshold (e.g., TG1) associated with the UE 115 switching from OFDM signal processing (e.g., legacy OFDM reception) to FMCW signal processing (e.g., FMCW reception), the second time threshold (e.g., TG2) associated with the UE 115 from FMCW signal processing to OFDM signal processing, the third time threshold (e.g., TG3) associated with the UE 115 performing FMCW-based OFDM channel estimation, or any combination thereof.

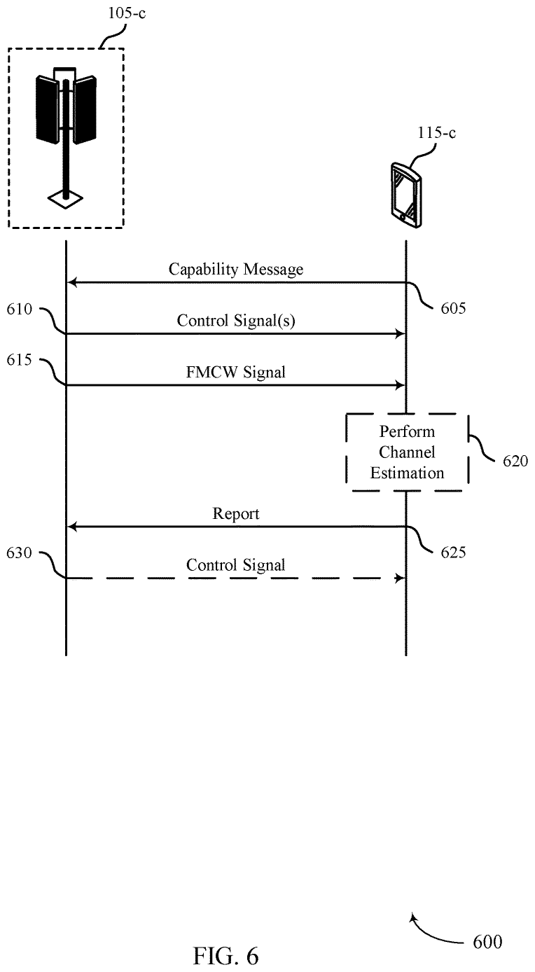

FIG. 6 illustrates an example of a process flow 600 that supports bandwidth part selection using FMCW-based OFDM channel estimation in accordance with one or more aspects of the present disclosure. In some examples, the process flow 600 may implement or be implemented by aspects of the wireless communications system 100, the wireless communications system 200, the wireless communications system 300, the channel estimation procedure 400, and the timing diagrams 500. For example, the process flow 600 may include on or more network entities 105 (e.g., network entity 105-c) and one or more UEs 115 (e.g., UE 115-c), which may be examples of the corresponding devices as described with reference to FIG. 1. In some examples, the network entity 105-c may transmit, to the UE 115-c, an FMCW signal via an OFDM channel, such that the FMCW signal may be used to facilitate channel estimation of the OFDM channel by the UE 115-c.

At 605, the UE 115-c may transmit (e.g., via an OFDM channel) an indication of a capability (e.g., capability message) of the UE 115-c to support channel estimation for a wideband using signaling via a narrowband (e.g., FMCW-based wideband OFDM channel estimation). The narrowband may be associated with a bandwidth that is less than a threshold bandwidth and the wideband may be associated with a bandwidth that is greater than the threshold bandwidth. In other words, the narrowband may be associated with one or more BWPs, including at least a first BWP, that are a subset of multiple BWPs associated with the wideband. That is, the UE 115-c (e.g., configured for narrowband processing) may communicate via the one or more BWPs (e.g., via the narrowband).

In some examples, the capability message may indicate one or more time thresholds associated with switching from receiving a first type of signaling, such as FMCW signaling, to receiving a second type of signaling, such as OFDM signaling, switching from receiving the second type of signaling to receiving the first type of signaling, performing a channel estimation procedure (e.g., channel estimation), or any combination thereof.

At 610, the UE 115-c may receive a first control signal indicating a resource occasion (e.g., time domain resources) for communication of an FMCW signal (e.g., wideband FMCW signal) via the first BWP of the multiple BWPs of the wideband. In some examples, the first control signal may include an indication of a start time, a start frequency, a duration, a bandwidth, a slope, or any combination thereof, associated with the FMCW signal. The duration may include one or more symbol lengths, a portion of a symbol length, one or more slot lengths, a portion of a slot length, a length of a CP (e.g., including or excluding a CP), or any combination thereof. As such, the resource occasion may be based on the start time, the start frequency, the duration, the bandwidth, the slope, or any combination thereof. In some examples, the first control signal may be a dynamic indication of the resource occasion or a semi-persistent indication of the resource occasion.

In some examples, the first control signal may include an indication of one or more resources associated with communicating (e.g., for transmitting) a report indicating one or more second BWPs of the multiple BWPs of the wideband based on the channel estimation procedure. Alternatively, the UE 115-c may receive a second control signal including the indication of the one or more resources for transmitting the report. In such cases, the second control signal may include DCI, a MAC-CE, or RRC signaling. Additionally, or alternatively, the first control signal, the second control signal, or a third control signal may indicate a set of BWP configurations.

At 615, the UE 115-c may receive, via the resource occasion and the first BWP of the multiple BWPs, the FMCW signal (e.g., wideband FMCW signal).

In some cases, at 620, the UE 115-c may perform the channel estimation (e.g., channel estimation procedure) based on the received FMCW signal. That is, the UE 115-c may combine the received FMCW signal (e.g., associated with the wideband) with a second FMCW signal generated at the UE 115-c to generate a combined FMCW signal (e.g., narrowband FMCW signal). As such, the UE 115-c may perform the channel estimation procedure based on samples of the combined FMCW signal. That is, the UE 115-c may extract the wideband from the combined FMCW signal to estimate the multiple BWPs of the wideband

At 625, the UE 115-c may transmit a report (e.g., BWP report) indicating the one or more second BWPs of the multiple BWPs of the wideband based on the channel estimation procedure associated with the multiple BWPs of the wideband. In some examples, the report may indicate a first BWP configuration (e.g., one or more first BWP configurations) from the set of BWP configurations, where the first BWP configuration is associated with the one or more second BWPs.

At 630, the UE 115-c may receive a fourth control signal indicating at least one BWP of the one or more second BWPs based on the report. For example, the fourth control signal may indicate the first BWP configuration (e.g., a BWP configuration from the one or more first BWP configurations) associated with the one or more second BWPs. As such, the UE 115-c may communicate (e.g., transmit or receive) via the at least one BWP of the one or more second BWPs. Additionally, the network entity 105-c may communicate (e.g., transmit/output or receive/obtain) with the UE 115-c via the at least one BWP of the one or more second BWPs.

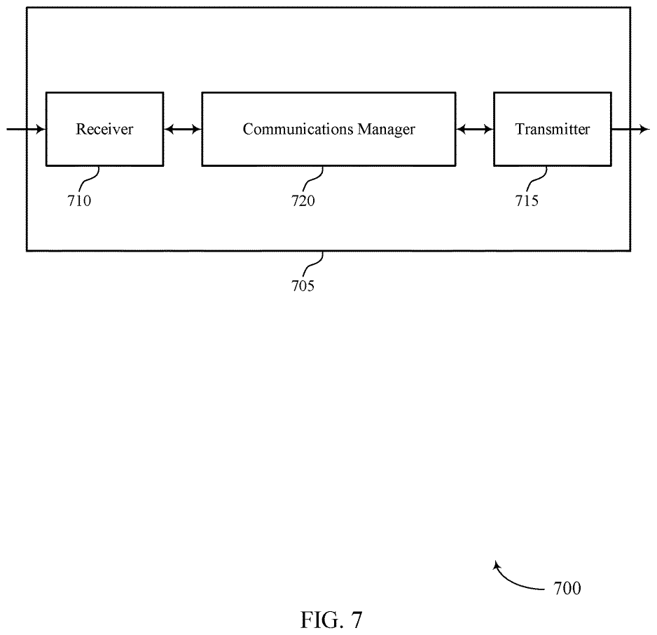

FIG. 7 illustrates a block diagram 700 of a device 705 that supports BWP selection using FMCW-based OFDM channel estimation in accordance with one or more aspects of the present disclosure. The device 705 may be an example of aspects of a UE 115 as described herein. The device 705 may include a receiver 710, a transmitter 715, and a communications manager 720. The device 705 may also include a processor. Each of these components may be in communication with one another (e.g., via one or more buses).

The receiver 710 may provide a means for receiving information such as packets, user data, control information, or any combination thereof associated with various information channels (e.g., control channels, data channels, information channels related to BWP selection using FMCW-based OFDM channel estimation). Information may be passed on to other components of the device 705. The receiver 710 may utilize a single antenna or a set of multiple antennas.

The transmitter 715 may provide a means for transmitting signals generated by other components of the device 705. For example, the transmitter 715 may transmit information such as packets, user data, control information, or any combination thereof associated with various information channels (e.g., control channels, data channels, information channels related to BWP selection using FMCW-based OFDM channel estimation). In some examples, the transmitter 715 may be co-located with a receiver 710 in a transceiver module. The transmitter 715 may utilize a single antenna or a set of multiple antennas.

The communications manager 720, the receiver 710, the transmitter 715, or various combinations thereof or various components thereof may be examples of means for performing various aspects of BWP selection using FMCW-based OFDM channel estimation as described herein. For example, the communications manager 720, the receiver 710, the transmitter 715, or various combinations or components thereof may support a method for performing one or more of the functions described herein.

In some examples, the communications manager 720, the receiver 710, the transmitter 715, or various combinations or components thereof may be implemented in hardware (e.g., in communications management circuitry). The hardware may include a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally, or alternatively, in some examples, the communications manager 720, the receiver 710, the transmitter 715, or various combinations or components thereof may be implemented in code (e.g., as communications management software or firmware) executed by a processor. If implemented in code executed by a processor, the functions of the communications manager 720, the receiver 710, the transmitter 715, or various combinations or components thereof may be performed by a general-purpose processor, a DSP, a CPU, an ASIC, an FPGA, a microcontroller, or any combination of these or other programmable logic devices (e.g., configured as or otherwise supporting a means for performing the functions described in the present disclosure).

In some examples, the communications manager 720 may be configured to perform various operations (e.g., receiving, obtaining, monitoring, outputting, transmitting) using or otherwise in cooperation with the receiver 710, the transmitter 715, or both. For example, the communications manager 720 may receive information from the receiver 710, send information to the transmitter 715, or be integrated in combination with the receiver 710, the transmitter 715, or both to obtain information, output information, or perform various other operations as described herein.

The communications manager 720 may support wireless communications at a UE in accordance with examples as disclosed herein. For example, the communications manager 720 may be configured as or otherwise support a means for transmitting an indication of a capability of the UE to support channel estimation for a wideband using signaling via a narrowband, where the narrowband is associated with a bandwidth that is less than a threshold bandwidth, and where the wideband is associated with a bandwidth that is greater than the threshold bandwidth. The communications manager 720 may be configured as or otherwise support a means for receiving a control signal indicating a resource occasion for communication of a FMCW signal via a first BWP of a set of multiple BWPs of the wideband. The communications manager 720 may be configured as or otherwise support a means for receiving, via the resource occasion and the first BWP of the set of multiple BWPs, the FMCW signal. The communications manager 720 may be configured as or otherwise support a means for transmitting a report indicating one or more second BWPs of the set of multiple BWPs of the wideband based on a channel estimation procedure associated with the set of multiple BWPs of the wideband, where the channel estimation procedure is based on the FMCW signal.

By including or configuring the communications manager 720 in accordance with examples as described herein, the device 705 (e.g., a processor controlling or otherwise coupled with the receiver 710, the transmitter 715, the communications manager 720, or a combination thereof) may support techniques for FMCW-based OFDM channel estimation which may result in reduced processing, reduced power consumption, and more efficient utilization of communication resources, among other benefits.

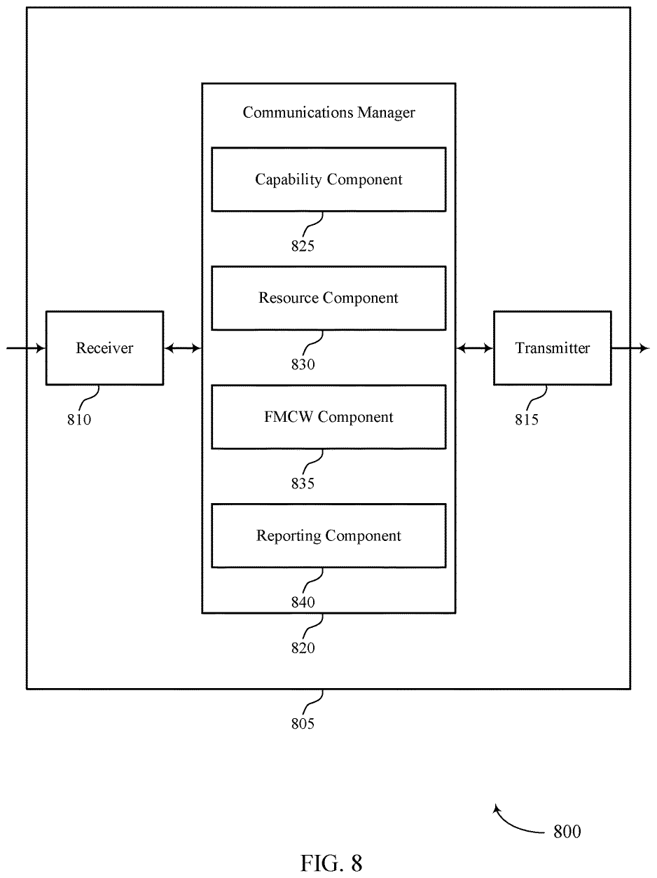

FIG. 8 illustrates a block diagram 800 of a device 805 that supports BWP selection using FMCW-based OFDM channel estimation in accordance with one or more aspects of the present disclosure. The device 805 may be an example of aspects of a device 705 or a UE 115 as described herein. The device 805 may include a receiver 810, a transmitter 815, and a communications manager 820. The device 805 may also include a processor. Each of these components may be in communication with one another (e.g., via one or more buses).

The receiver 810 may provide a means for receiving information such as packets, user data, control information, or any combination thereof associated with various information channels (e.g., control channels, data channels, information channels related to BWP selection using FMCW-based OFDM channel estimation).

Information may be passed on to other components of the device 805. The receiver 810 may utilize a single antenna or a set of multiple antennas.

The transmitter 815 may provide a means for transmitting signals generated by other components of the device 805. For example, the transmitter 815 may transmit information such as packets, user data, control information, or any combination thereof associated with various information channels (e.g., control channels, data channels, information channels related to BWP selection using FMCW-based OFDM channel estimation). In some examples, the transmitter 815 may be co-located with a receiver 810 in a transceiver module. The transmitter 815 may utilize a single antenna or a set of multiple antennas.

The device 805, or various components thereof, may be an example of means for performing various aspects of BWP selection using FMCW-based OFDM channel estimation as described herein. For example, the communications manager 820 may include a capability component 825, a resource component 830, an FMCW component 835, a reporting component 840, or any combination thereof. The communications manager 820 may be an example of aspects of a communications manager 720 as described herein. In some examples, the communications manager 820, or various components thereof, may be configured to perform various operations (e.g., receiving, obtaining, monitoring, outputting, transmitting) using or otherwise in cooperation with the receiver 810, the transmitter 815, or both. For example, the communications manager 820 may receive information from the receiver 810, send information to the transmitter 815, or be integrated in combination with the receiver 810, the transmitter 815, or both to obtain information, output information, or perform various other operations as described herein.

The communications manager 820 may support wireless communications at a UE in accordance with examples as disclosed herein. The capability component 825 may be configured as or otherwise support a means for transmitting an indication of a capability of the UE to support channel estimation for a wideband using signaling via a narrowband, where the narrowband is associated with a bandwidth that is less than a threshold bandwidth, and where the wideband is associated with a bandwidth that is greater than the threshold bandwidth. The resource component 830 may be configured as or otherwise support a means for receiving a control signal indicating a resource occasion for communication of a FMCW signal via a first BWP of a set of multiple BWPs of the wideband. The FMCW component 835 may be configured as or otherwise support a means for receiving, via the resource occasion and the first BWP of the set of multiple BWPs, the FMCW signal. The reporting component 840 may be configured as or otherwise support a means for transmitting a report indicating one or more second BWPs of the set of multiple BWPs of the wideband based on a channel estimation procedure associated with the set of multiple BWPs of the wideband, where the channel estimation procedure is based on the FMCW signal.

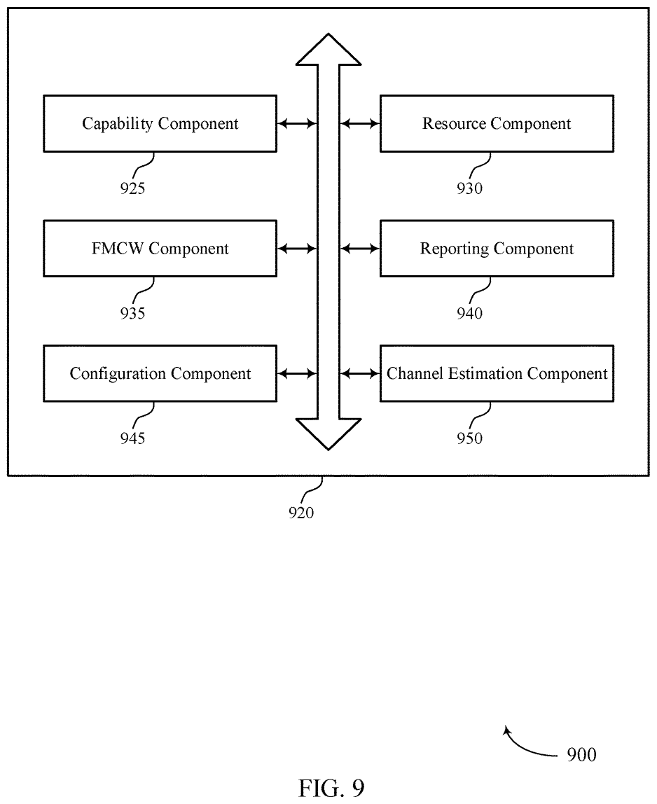

FIG. 9 illustrates a block diagram 900 of a communications manager 920 that supports BWP selection using FMCW-based OFDM channel estimation in accordance with one or more aspects of the present disclosure. The communications manager 920 may be an example of aspects of a communications manager 720, a communications manager 820, or both, as described herein. The communications manager 920, or various components thereof, may be an example of means for performing various aspects of BWP selection using FMCW-based OFDM channel estimation as described herein. For example, the communications manager 920 may include a capability component 925, a resource component 930, an FMCW component 935, a reporting component 940, a configuration component 945, a channel estimation component 950, or any combination thereof. Each of these components may communicate, directly or indirectly, with one another (e.g., via one or more buses).

The communications manager 920 may support wireless communications at a UE in accordance with examples as disclosed herein. The capability component 925 may be configured as or otherwise support a means for transmitting an indication of a capability of the UE to support channel estimation for a wideband using signaling via a narrowband, where the narrowband is associated with a bandwidth that is less than a threshold bandwidth, and where the wideband is associated with a bandwidth that is greater than the threshold bandwidth. The resource component 930 may be configured as or otherwise support a means for receiving a control signal indicating a resource occasion for communication of a FMCW signal via a first BWP of a set of multiple BWPs of the wideband. The FMCW component 935 may be configured as or otherwise support a means for receiving, via the resource occasion and the first BWP of the set of multiple BWPs, the FMCW signal. The reporting component 940 may be configured as or otherwise support a means for transmitting a report indicating one or more second BWPs of the set of multiple BWPs of the wideband based on a channel estimation procedure associated with the set of multiple BWPs of the wideband, where the channel estimation procedure is based on the FMCW signal.

In some examples, to support transmitting the indication of the capability of the UE, the capability component 925 may be configured as or otherwise support a means for transmitting an indication of one or more time thresholds associated with switching from receiving a first type of signaling to receiving a second type of signaling, switching from receiving the second type of signaling to receiving the first type of signaling, performing the channel estimation procedure, or any combination thereof.

In some examples, the first type of signaling is FMCW signaling and the second type of signaling is OFDM signaling.

In some examples, to support receiving the indication of the resource occasion, the resource component 930 may be configured as or otherwise support a means for receiving an indication of a start time, a start frequency, a duration, a bandwidth, a slope, or any combination thereof, associated with the FMCW signal, where the resource occasion is based on the start time, the start frequency, the duration, the bandwidth, the slope, or any combination thereof.

In some examples, the duration includes one or more symbol lengths, a portion of a symbol length, one or more slot lengths, a portion of a slot length, a length of a CP, or any combination thereof.

In some examples, the resource component 930 may be configured as or otherwise support a means for receiving an indication of one or more resources associated with communicating the report indicating one or more second BWPs, where the report is transmitted via the one or more resources.

In some examples, the control signal includes the indication of the one or more resources.

In some examples, the indication of the one or more resources is received via a second control signal. In some examples, the second control signal includes DCI, a MAC-CE, or RRC signaling.

In some examples, the configuration component 945 may be configured as or otherwise support a means for receiving a second control signal indicating a set of BWP configurations, where the report includes an indication of a first BWP configuration from the set of BWP configurations, and where the first BWP configuration is associated with the one or more second BWPs.

In some examples, the control signal includes DCI, a MAC-CE, or a RRC signal.

In some examples, the control signal is a dynamic indication of the resource occasion or a semi-persistent indication of the resource occasion.

In some examples, the channel estimation component 950 may be configured as or otherwise support a means for performing the channel estimation procedure based on samples of a combined FMCW signal, the combined FMCW signal including a combination of the received FMCW signal and a second FMCW signal generated at the UE.

In some examples, to support performing the channel estimation procedure, the channel estimation component 950 may be configured as or otherwise support a means for estimating the set of multiple BWPs of the wideband based on extracting the wideband from the combined FMCW signal.

In some examples, the received FMCW signal is associated with the wideband. In some examples, the combined FMCW signal is associated with the narrowband.

In some examples, the configuration component 945 may be configured as or otherwise support a means for receiving a second control signal indicating at least one BWP of the one or more second BWPs based on the report. In some examples, the configuration component 945 may be configured as or otherwise support a means for communicating via the at least one BWP of the one or more second BWPs.

In some examples, the first BWP is of one or more BWPs associated with the narrowband.

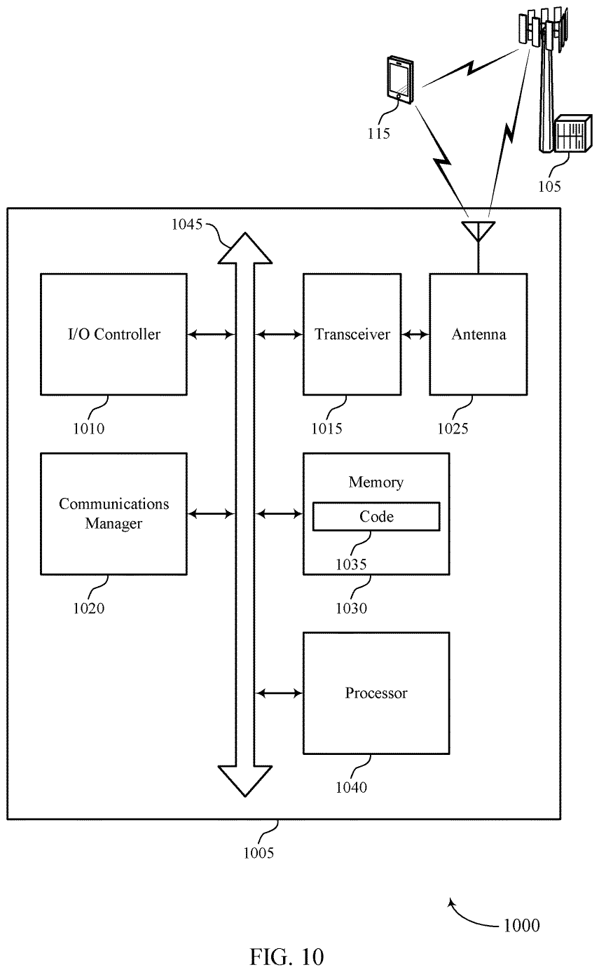

FIG. 10 illustrates a diagram of a system 1000 including a device 1005 that supports BWP selection using FMCW-based OFDM channel estimation in accordance with one or more aspects of the present disclosure. The device 1005 may be an example of or include the components of a device 705, a device 805, or a UE 115 as described herein. The device 1005 may communicate (e.g., wirelessly) with one or more network entities 105, one or more UEs 115, or any combination thereof. The device 1005 may include components for bi-directional voice and data communications including components for transmitting and receiving communications, such as a communications manager 1020, an input/output (I/O) controller 1010, a transceiver 1015, an antenna 1025, a memory 1030, code 1035, and a processor 1040. These components may be in electronic communication or otherwise coupled (e.g., operatively, communicatively, functionally, electronically, electrically) via one or more buses (e.g., a bus 1045).

The I/O controller 1010 may manage input and output signals for the device 1005. The I/O controller 1010 may also manage peripherals not integrated into the device 1005. In some cases, the I/O controller 1010 may represent a physical connection or port to an external peripheral. In some cases, the I/O controller 1010 may utilize an operating system such as iOS®, ANDROID®, MS-DOS®, MS-WINDOWS®, OS/2®, UNIX®, LINUX®, or another known operating system. Additionally, or alternatively, the I/O controller 1010 may represent or interact with a modem, a keyboard, a mouse, a touchscreen, or a similar device. In some cases, the I/O controller 1010 may be implemented as part of a processor, such as the processor 1040. In some cases, a user may interact with the device 1005 via the I/O controller 1010 or via hardware components controlled by the I/O controller 1010.

In some cases, the device 1005 may include a single antenna 1025. However, in some other cases, the device 1005 may have more than one antenna 1025, which may be capable of concurrently transmitting or receiving multiple wireless transmissions.

The transceiver 1015 may communicate bi-directionally, via the one or more antennas 1025, wired, or wireless links as described herein. For example, the transceiver 1015 may represent a wireless transceiver and may communicate bi-directionally with another wireless transceiver. The transceiver 1015 may also include a modem to modulate the packets, to provide the modulated packets to one or more antennas 1025 for transmission, and to demodulate packets received from the one or more antennas 1025. The transceiver 1015, or the transceiver 1015 and one or more antennas 1025, may be an example of a transmitter 715, a transmitter 815, a receiver 710, a receiver 810, or any combination thereof or component thereof, as described herein.

The memory 1030 may include random access memory (RAM) and read-only memory (ROM). The memory 1030 may store computer-readable, computer-executable code 1035 including instructions that, when executed by the processor 1040, cause the device 1005 to perform various functions described herein. The code 1035 may be stored in a non-transitory computer-readable medium such as system memory or another type of memory. In some cases, the code 1035 may not be directly executable by the processor 1040 but may cause a computer (e.g., when compiled and executed) to perform functions described herein. In some cases, the memory 1030 may contain, among other things, a basic I/O system (BIOS) which may control basic hardware or software operation such as the interaction with peripheral components or devices.

The processor 1040 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 1040 may be configured to operate a memory array using a memory controller. In some other cases, a memory controller may be integrated into the processor 1040. The processor 1040 may be configured to execute computer-readable instructions stored in a memory (e.g., the memory 1030) to cause the device 1005 to perform various functions (e.g., functions or tasks supporting BWP selection using FMCW-based OFDM channel estimation). For example, the device 1005 or a component of the device 1005 may include a processor 1040 and memory 1030 coupled with or to the processor 1040, the processor 1040 and memory 1030 configured to perform various functions described herein.

The communications manager 1020 may support wireless communications at a UE in accordance with examples as disclosed herein. For example, the communications manager 1020 may be configured as or otherwise support a means for transmitting an indication of a capability of the UE to support channel estimation for a wideband using signaling via a narrowband, where the narrowband is associated with a bandwidth that is less than a threshold bandwidth, and where the wideband is associated with a bandwidth that is greater than the threshold bandwidth. The communications manager 1020 may be configured as or otherwise support a means for receiving a control signal indicating a resource occasion for communication of a FMCW signal via a first BWP of a set of multiple BWPs of the wideband. The communications manager 1020 may be configured as or otherwise support a means for receiving, via the resource occasion and the first BWP of the set of multiple BWPs, the FMCW signal. The communications manager 1020 may be configured as or otherwise support a means for transmitting a report indicating one or more second BWPs of the set of multiple BWPs of the wideband based on a channel estimation procedure associated with the set of multiple BWPs of the wideband, where the channel estimation procedure is based on the FMCW signal.

By including or configuring the communications manager 1020 in accordance with examples as described herein, the device 1005 may support techniques for FMCW-based OFDM channel estimation which may result in improved communication reliability, reduced latency, improved user experience related to reduced processing, reduced power consumption, more efficient utilization of communication resources, improved coordination between devices, longer battery life, and improved utilization of processing capability, among other advantages.

In some examples, the communications manager 1020 may be configured to perform various operations (e.g., receiving, monitoring, transmitting) using or otherwise in cooperation with the transceiver 1015, the one or more antennas 1025, or any combination thereof. Although the communications manager 1020 is illustrated as a separate component, in some examples, one or more functions described with reference to the communications manager 1020 may be supported by or performed by the processor 1040, the memory 1030, the code 1035, or any combination thereof. For example, the code 1035 may include instructions executable by the processor 1040 to cause the device 1005 to perform various aspects of BWP selection using FMCW-based OFDM channel estimation as described herein, or the processor 1040 and the memory 1030 may be otherwise configured to perform or support such operations.

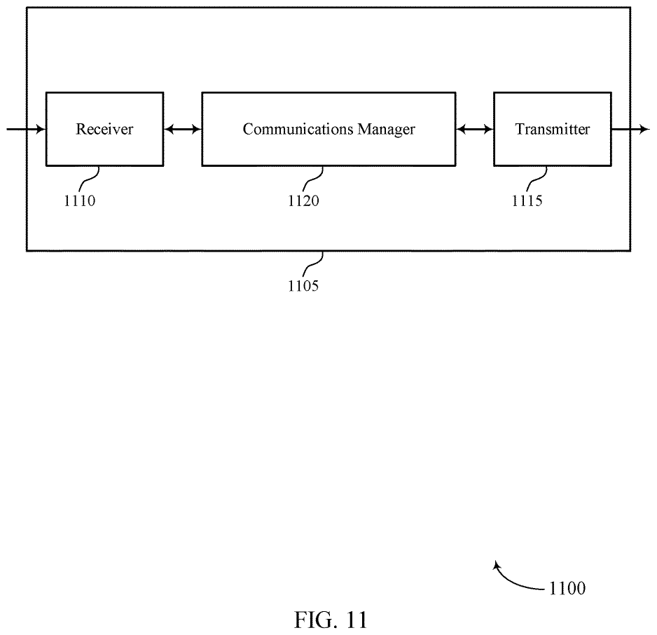

FIG. 11 illustrates a block diagram 1100 of a device 1105 that supports BWP selection using FMCW-based OFDM channel estimation in accordance with one or more aspects of the present disclosure. The device 1105 may be an example of aspects of a network entity 105 as described herein. The device 1105 may include a receiver 1110, a transmitter 1115, and a communications manager 1120. The device 1105 may also include a processor. Each of these components may be in communication with one another (e.g., via one or more buses).

The receiver 1110 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1105. In some examples, the receiver 1110 may support obtaining information by receiving signals via one or more antennas.

Additionally, or alternatively, the receiver 1110 may support obtaining information by receiving signals via one or more wired (e.g., electrical, fiber optic) interfaces, wireless interfaces, or any combination thereof.

The transmitter 1115 may provide a means for outputting (e.g., transmitting, providing, conveying, sending) information generated by other components of the device 1105. For example, the transmitter 1115 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1115 may support outputting information by transmitting signals via one or more antennas. Additionally, or alternatively, the transmitter 1115 may support outputting information by transmitting signals via one or more wired (e.g., electrical, fiber optic) interfaces, wireless interfaces, or any combination thereof. In some examples, the transmitter 1115 and the receiver 1110 may be co-located in a transceiver, which may include or be coupled with a modem.

The communications manager 1120, the receiver 1110, the transmitter 1115, or various combinations thereof or various components thereof may be examples of means for performing various aspects of BWP selection using FMCW-based OFDM channel estimation as described herein. For example, the communications manager 1120, the receiver 1110, the transmitter 1115, or various combinations or components thereof may support a method for performing one or more of the functions described herein.

In some examples, the communications manager 1120, the receiver 1110, the transmitter 1115, or various combinations or components thereof may be implemented in hardware (e.g., in communications management circuitry). The hardware may include a processor, a DSP, a CPU, an ASIC, an FPGA or other programmable logic device, a microcontroller, discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally, or alternatively, in some examples, the communications manager 1120, the receiver 1110, the transmitter 1115, or various combinations or components thereof may be implemented in code (e.g., as communications management software or firmware) executed by a processor. If implemented in code executed by a processor, the functions of the communications manager 1120, the receiver 1110, the transmitter 1115, or various combinations or components thereof may be performed by a general-purpose processor, a DSP, a CPU, an ASIC, an FPGA, a microcontroller, or any combination of these or other programmable logic devices (e.g., configured as or otherwise supporting a means for performing the functions described in the present disclosure).

In some examples, the communications manager 1120 may be configured to perform various operations (e.g., receiving, obtaining, monitoring, outputting, transmitting) using or otherwise in cooperation with the receiver 1110, the transmitter 1115, or both. For example, the communications manager 1120 may receive information from the receiver 1110, send information to the transmitter 1115, or be integrated in combination with the receiver 1110, the transmitter 1115, or both to obtain information, output information, or perform various other operations as described herein.

The communications manager 1120 may support wireless communications at a network entity in accordance with examples as disclosed herein. For example, the communications manager 1120 may be configured as or otherwise support a means for receiving an indication of a capability of a UE to support channel estimation for a wideband using signaling via a narrowband, where the narrowband is associated with a bandwidth that is less than a threshold bandwidth, and where the wideband is associated with a bandwidth that is greater than the threshold bandwidth. The communications manager 1120 may be configured as or otherwise support a means for transmitting a control signal indicating a resource occasion for communication of a FMCW signal via a first BWP of a set of multiple BWPs of the wideband. The communications manager 1120 may be configured as or otherwise support a means for communicating, via the resource occasion and the first BWP of the set of multiple BWPs, the FMCW signal.

The communications manager 1120 may be configured as or otherwise support a means for receiving a report indicating one or more second BWPs of the set of multiple BWPs of the wideband based on a channel estimation procedure associated with the set of multiple BWPs of the wideband, where the channel estimation procedure is based on the narrowband FMCW signal.

By including or configuring the communications manager 1120 in accordance with examples as described herein, the device 1105 (e.g., a processor controlling or otherwise coupled with the receiver 1110, the transmitter 1115, the communications manager 1120, or a combination thereof) may support techniques for FMCW-based OFDM channel estimation which may result in reduced processing, reduced power consumption, and more efficient utilization of communication resources, among other advantages.

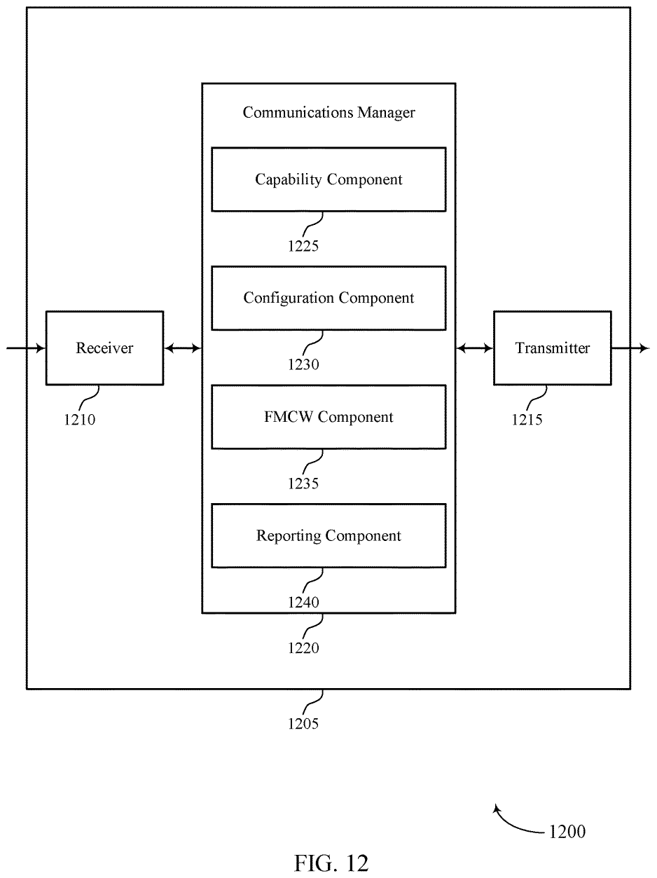

FIG. 12 illustrates a block diagram 1200 of a device 1205 that supports BWP selection using FMCW-based OFDM channel estimation in accordance with one or more aspects of the present disclosure. The device 1205 may be an example of aspects of a device 1105 or a network entity 105 as described herein. The device 1205 may include a receiver 1210, a transmitter 1215, and a communications manager 1220. The device 1205 may also include a processor. Each of these components may be in communication with one another (e.g., via one or more buses).

The receiver 1210 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1205. In some examples, the receiver 1210 may support obtaining information by receiving signals via one or more antennas. Additionally, or alternatively, the receiver 1210 may support obtaining information by receiving signals via one or more wired (e.g., electrical, fiber optic) interfaces, wireless interfaces, or any combination thereof.

The transmitter 1215 may provide a means for outputting (e.g., transmitting, providing, conveying, sending) information generated by other components of the device 1205. For example, the transmitter 1215 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1215 may support outputting information by transmitting signals via one or more antennas. Additionally, or alternatively, the transmitter 1215 may support outputting information by transmitting signals via one or more wired (e.g., electrical, fiber optic) interfaces, wireless interfaces, or any combination thereof. In some examples, the transmitter 1215 and the receiver 1210 may be co-located in a transceiver, which may include or be coupled with a modem.

The device 1205, or various components thereof, may be an example of means for performing various aspects of BWP selection using FMCW-based OFDM channel estimation as described herein. For example, the communications manager 1220 may include a capability component 1225, a configuration component 1230, an FMCW component 1235, a reporting component 1240, or any combination thereof. The communications manager 1220 may be an example of aspects of a communications manager 1120 as described herein. In some examples, the communications manager 1220, or various components thereof, may be configured to perform various operations (e.g., receiving, obtaining, monitoring, outputting, transmitting) using or otherwise in cooperation with the receiver 1210, the transmitter 1215, or both. For example, the communications manager 1220 may receive information from the receiver 1210, send information to the transmitter 1215, or be integrated in combination with the receiver 1210, the transmitter 1215, or both to obtain information, output information, or perform various other operations as described herein.

The communications manager 1220 may support wireless communications at a network entity in accordance with examples as disclosed herein. The capability component 1225 may be configured as or otherwise support a means for receiving an indication of a capability of a UE to support channel estimation for a wideband using signaling via a narrowband, where the narrowband is associated with a bandwidth that is less than a threshold bandwidth, and where the wideband is associated with a bandwidth that is greater than the threshold bandwidth. The configuration component 1230 may be configured as or otherwise support a means for transmitting a control signal indicating a resource occasion for communication of a FMCW signal via a first BWP of a set of multiple BWPs of the wideband. The FMCW component 1235 may be configured as or otherwise support a means for communicating, via the resource occasion and the first BWP of the set of multiple BWPs, the FMCW signal. The reporting component 1240 may be configured as or otherwise support a means for receiving a report indicating one or more second BWPs of the set of multiple BWPs of the wideband based on a channel estimation procedure associated with the set of multiple BWPs of the wideband, where the channel estimation procedure is based on the narrowband FMCW signal.

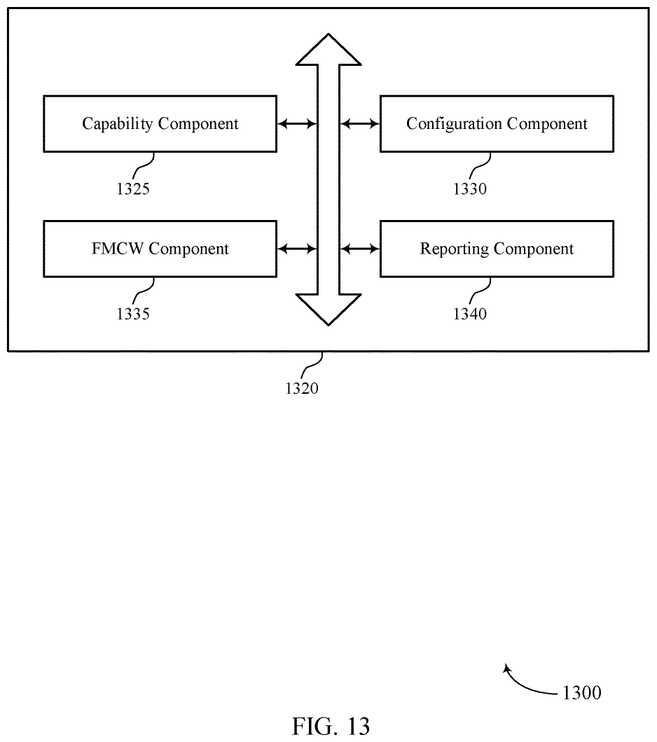

FIG. 13 illustrates a block diagram 1300 of a communications manager 1320 that supports BWP selection using FMCW-based OFDM channel estimation in accordance with one or more aspects of the present disclosure. The communications manager 1320 may be an example of aspects of a communications manager 1120, a communications manager 1220, or both, as described herein. The communications manager 1320, or various components thereof, may be an example of means for performing various aspects of BWP selection using FMCW-based OFDM channel estimation as described herein. For example, the communications manager 1320 may include a capability component 1325, a configuration component 1330, an FMCW component 1335, a reporting component 1340, or any combination thereof. Each of these components may communicate, directly or indirectly, with one another (e.g., via one or more buses) which may include communications within a protocol layer of a protocol stack, communications associated with a logical channel of a protocol stack (e.g., between protocol layers of a protocol stack, within a device, component, or virtualized component associated with a network entity 105, between devices, components, or virtualized components associated with a network entity 105), or any combination thereof.

The communications manager 1320 may support wireless communications at a network entity in accordance with examples as disclosed herein. The capability component 1325 may be configured as or otherwise support a means for receiving an indication of a capability of a UE to support channel estimation for a wideband using signaling via a narrowband, where the narrowband is associated with a bandwidth that is less than a threshold bandwidth, and where the wideband is associated with a bandwidth that is greater than the threshold bandwidth. The configuration component 1330 may be configured as or otherwise support a means for transmitting a control signal indicating a resource occasion for communication of a FMCW signal via a first BWP of a set of multiple BWPs of the wideband. The FMCW component 1335 may be configured as or otherwise support a means for communicating, via the resource occasion and the first BWP of the set of multiple BWPs, the FMCW signal. The reporting component 1340 may be configured as or otherwise support a means for receiving a report indicating one or more second BWPs of the set of multiple BWPs of the wideband based on a channel estimation procedure associated with the set of multiple BWPs of the wideband, where the channel estimation procedure is based on the narrowband FMCW signal.

In some examples, to support receiving the indication of the capability of the UE, the capability component 1325 may be configured as or otherwise support a means for receiving an indication of one or more time thresholds associated with switching from receiving a first type of signaling to receiving a second type of signaling, switching from receiving the second type of signaling to receiving the first type of signaling, performing the channel estimation procedure, or any combination thereof.

In some examples, the first type of signaling is FMCW signaling and the second type of signaling is OFDM signaling.

In some examples, to support transmitting the indication of the resource occasion, the configuration component 1330 may be configured as or otherwise support a means for transmitting an indication of a start time, a start frequency, a duration, a bandwidth, a slope, or any combination thereof, associated with the FMCW signal, where the resource occasion is based on the start time, the start frequency, the duration, the bandwidth, the slope, or any combination thereof.

In some examples, the duration includes one or more symbol lengths, a portion of a symbol length, one or more slot lengths, a portion of a slot length, a length of a CP, or any combination thereof.

In some examples, the configuration component 1330 may be configured as or otherwise support a means for transmitting an indication of one or more resources associated with communicating the report indicating one or more second BWPs, where the report is received via the one or more resources.

In some examples, the control signaling includes the indication of the one or more resources.

In some examples, the indication of the one or more resources is received via a second control signal. In some examples, the second control signal includes DCI, a MAC-CE, or RRC signaling.

In some examples, the configuration component 1330 may be configured as or otherwise support a means for transmitting a second control signal indicating a set of BWP configurations, where the report includes an indication of a first BWP configuration from the set of BWP configurations, and where the first BWP configuration is associated with the one or more second BWPs.

In some examples, the control signal includes DCI, a MAC-CE, or a RRC signal.

In some examples, the control signal includes a dynamic indication of the resource occasion or a semi-persistent indication of the resource occasion.

In some examples, the FMCW signal is communicated via unicast, groupcast, broadcast, or multicast.

In some examples, the configuration component 1330 may be configured as or otherwise support a means for transmitting a second control signal indicating at least one BWP of the one or more second BWPs based on the report. In some examples, the configuration component 1330 may be configured as or otherwise support a means for communicating via the at least one BWP of the one or more second BWPs.

In some examples, the first BWP is of one or more BWPs associated with the narrowband.

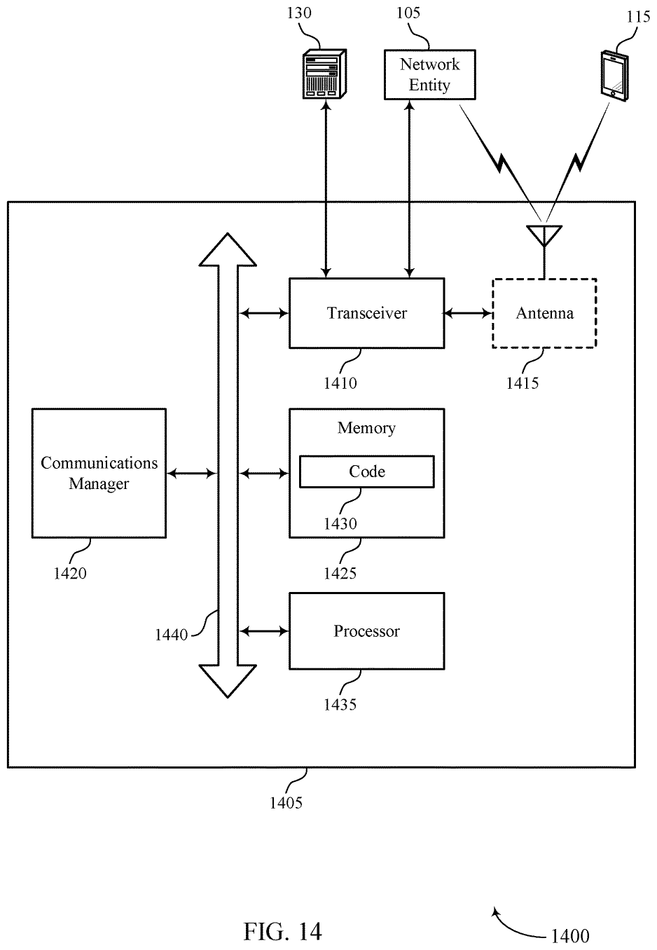

FIG. 14 illustrates a diagram of a system 1400 including a device 1405 that supports BWP selection using FMCW-based OFDM channel estimation in accordance with one or more aspects of the present disclosure. The device 1405 may be an example of or include the components of a device 1105, a device 1205, or a network entity 105 as described herein. The device 1405 may communicate with one or more network entities 105, one or more UEs 115, or any combination thereof, which may include communications over one or more wired interfaces, over one or more wireless interfaces, or any combination thereof. The device 1405 may include components that support outputting and obtaining communications, such as a communications manager 1420, a transceiver 1410, an antenna 1415, a memory 1425, code 1430, and a processor 1435. These components may be in electronic communication or otherwise coupled (e.g., operatively, communicatively, functionally, electronically, electrically) via one or more buses (e.g., a bus 1440).

The transceiver 1410 may support bi-directional communications via wired links, wireless links, or both as described herein. In some examples, the transceiver 1410 may include a wired transceiver and may communicate bi-directionally with another wired transceiver. Additionally, or alternatively, in some examples, the transceiver 1410 may include a wireless transceiver and may communicate bi-directionally with another wireless transceiver. In some examples, the device 1405 may include one or more antennas 1415, which may be capable of transmitting or receiving wireless transmissions (e.g., concurrently). The transceiver 1410 may also include a modem to modulate signals, to provide the modulated signals for transmission (e.g., by one or more antennas 1415, by a wired transmitter), to receive modulated signals (e.g., from one or more antennas 1415, from a wired receiver), and to demodulate signals. In some implementations, the transceiver 1410 may include one or more interfaces, such as one or more interfaces coupled with the one or more antennas 1415 that are configured to support various receiving or obtaining operations, or one or more interfaces coupled with the one or more antennas 1415 that are configured to support various transmitting or outputting operations, or a combination thereof. In some implementations, the transceiver 1410 may include or be configured for coupling with one or more processors or memory components that are operable to perform or support operations based on received or obtained information or signals, or to generate information or other signals for transmission or other outputting, or any combination thereof. In some implementations, the transceiver 1410, or the transceiver 1410 and the one or more antennas 1415, or the transceiver 1410 and the one or more antennas 1415 and one or more processors or memory components (for example, the processor 1435, or the memory 1425, or both), may be included in a chip or chip assembly that is installed in the device 1405. In some examples, the transceiver may be operable to support communications via one or more communications links (e.g., a communication link 125, a backhaul communication link 120, a midhaul communication link 162, a fronthaul communication link 168).

The memory 1425 may include RAM and ROM. The memory 1425 may store computer-readable, computer-executable code 1430 including instructions that, when executed by the processor 1435, cause the device 1405 to perform various functions described herein. The code 1430 may be stored in a non-transitory computer-readable medium such as system memory or another type of memory. In some cases, the code 1430 may not be directly executable by the processor 1435 but may cause a computer (e.g., when compiled and executed) to perform functions described herein. In some cases, the memory 1425 may contain, among other things, a BIOS which may control basic hardware or software operation such as the interaction with peripheral components or devices.

The processor 1435 may include an intelligent hardware device (e.g., a general-purpose processor, a DSP, an ASIC, a CPU, an FPGA, a microcontroller, a programmable logic device, discrete gate or transistor logic, a discrete hardware component, or any combination thereof). In some cases, the processor 1435 may be configured to operate a memory array using a memory controller. In some other cases, a memory controller may be integrated into the processor 1435. The processor 1435 may be configured to execute computer-readable instructions stored in a memory (e.g., the memory 1425) to cause the device 1405 to perform various functions (e.g., functions or tasks supporting BWP selection using FMCW-based OFDM channel estimation). For example, the device 1405 or a component of the device 1405 may include a processor 1435 and memory 1425 coupled with the processor 1435, the processor 1435 and memory 1425 configured to perform various functions described herein. The processor 1435 may be an example of a cloud-computing platform (e.g., one or more physical nodes and supporting software such as operating systems, virtual machines, or container instances) that may host the functions (e.g., by executing code 1430) to perform the functions of the device 1405. The processor 1435 may be any one or more suitable processors capable of executing scripts or instructions of one or more software programs stored in the device 1405 (such as within the memory 1425). In some implementations, the processor 1435 may be a component of a processing system. A processing system may generally refer to a system or series of machines or components that receives inputs and processes the inputs to produce a set of outputs (which may be passed to other systems or components of, for example, the device 1405). For example, a processing system of the device 1405 may refer to a system including the various other components or subcomponents of the device 1405, such as the processor 1435, or the transceiver 1410, or the communications manager 1420, or other components or combinations of components of the device 1405. The processing system of the device 1405 may interface with other components of the device 1405, and may process information received from other components (such as inputs or signals) or output information to other components. For example, a chip or modem of the device 1405 may include a processing system and one or more interfaces to output information, or to obtain information, or both. The one or more interfaces may be implemented as or otherwise include a first interface configured to output information and a second interface configured to obtain information, or a same interface configured to output information and to obtain information, among other implementations. In some implementations, the one or more interfaces may refer to an interface between the processing system of the chip or modem and a transmitter, such that the device 1405 may transmit information output from the chip or modem. Additionally, or alternatively, in some implementations, the one or more interfaces may refer to an interface between the processing system of the chip or modem and a receiver, such that the device 1405 may obtain information or signal inputs, and the information may be passed to the processing system. A person having ordinary skill in the art will readily recognize that a first interface also may obtain information or signal inputs, and a second interface also may output information or signal outputs.

In some examples, a bus 1440 may support communications of (e.g., within) a protocol layer of a protocol stack. In some examples, a bus 1440 may support communications associated with a logical channel of a protocol stack (e.g., between protocol layers of a protocol stack), which may include communications performed within a component of the device 1405, or between different components of the device 1405 that may be co-located or located in different locations (e.g., where the device 1405 may refer to a system in which one or more of the communications manager 1420, the transceiver 1410, the memory 1425, the code 1430, and the processor 1435 may be located in one of the different components or divided between different components).

In some examples, the communications manager 1420 may manage aspects of communications with a core network 130 (e.g., via one or more wired or wireless backhaul links). For example, the communications manager 1420 may manage the transfer of data communications for client devices, such as one or more UEs 115. In some examples, the communications manager 1420 may manage communications with other network entities 105, and may include a controller or scheduler for controlling communications with UEs 115 in cooperation with other network entities 105. In some examples, the communications manager 1420 may support an X2 interface within an LTE/LTE-A wireless communications network technology to provide communication between network entities 105.

The communications manager 1420 may support wireless communications at a network entity in accordance with examples as disclosed herein. For example, the communications manager 1420 may be configured as or otherwise support a means for receiving an indication of a capability of a UE to support channel estimation for a wideband using signaling via a narrowband, where the narrowband is associated with a bandwidth that is less than a threshold bandwidth, and where the wideband is associated with a bandwidth that is greater than the threshold bandwidth. The communications manager 1420 may be configured as or otherwise support a means for transmitting a control signal indicating a resource occasion for communication of a FMCW signal via a first BWP of a set of multiple BWPs of the wideband. The communications manager 1420 may be configured as or otherwise support a means for communicating, via the resource occasion and the first BWP of the set of multiple BWPs, the FMCW signal. The communications manager 1420 may be configured as or otherwise support a means for receiving a report indicating one or more second BWPs of the set of multiple BWPs of the wideband based on a channel estimation procedure associated with the set of multiple BWPs of the wideband, where the channel estimation procedure is based on the narrowband FMCW signal.

By including or configuring the communications manager 1420 in accordance with examples as described herein, the device 1405 may support techniques for FMCW-based OFDM channel estimation which may result in improved communication reliability, reduced latency, improved user experience related to reduced processing, reduced power consumption, more efficient utilization of communication resources, improved coordination between devices, longer battery life, and improved utilization of processing capability, among other advantages,.

In some examples, the communications manager 1420 may be configured to perform various operations (e.g., receiving, obtaining, monitoring, outputting, transmitting) using or otherwise in cooperation with the transceiver 1410, the one or more antennas 1415 (e.g., where applicable), or any combination thereof. Although the communications manager 1420 is illustrated as a separate component, in some examples, one or more functions described with reference to the communications manager 1420 may be supported by or performed by the transceiver 1410, the processor 1435, the memory 1425, the code 1430, or any combination thereof. For example, the code 1430 may include instructions executable by the processor 1435 to cause the device 1405 to perform various aspects of BWP selection using FMCW-based OFDM channel estimation as described herein, or the processor 1435 and the memory 1425 may be otherwise configured to perform or support such operations.

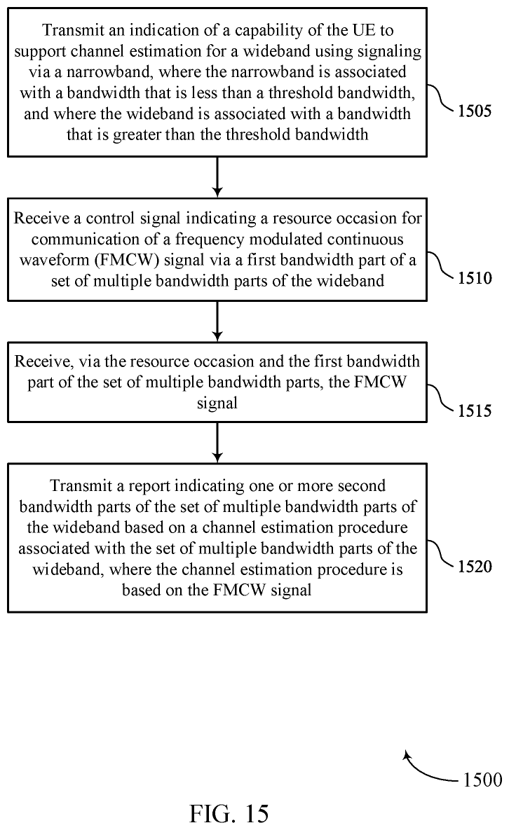

FIG. 15 illustrates a flowchart showing a method 1500 that supports BWP selection using FMCW-based OFDM channel estimation in accordance with one or more aspects of the present disclosure. The operations of the method 1500 may be implemented by a UE or its components as described herein. For example, the operations of the method 1500 may be performed by a UE 115 as described with reference to FIGS. 1 through 10. In some examples, a UE may execute a set of instructions to control the functional elements of the UE to perform the described functions. Additionally, or alternatively, the UE may perform aspects of the described functions using special-purpose hardware.

At 1505, the method may include transmitting an indication of a capability of the UE to support channel estimation for a wideband using signaling via a narrowband, where the narrowband is associated with a bandwidth that is less than a threshold bandwidth, and where the wideband is associated with a bandwidth that is greater than the threshold bandwidth. The operations of 1505 may be performed in accordance with examples as disclosed herein. In some examples, aspects of the operations of 1505 may be performed by a capability component 925 as described with reference to FIG. 9.

At 1510, the method may include receiving a control signal indicating a resource occasion for communication of a FMCW signal via a first BWP of a set of multiple BWPs of the wideband. The operations of 1510 may be performed in accordance with examples as disclosed herein. In some examples, aspects of the operations of 1510 may be performed by a resource component 930 as described with reference to FIG. 9.

At 1515, the method may include receiving, via the resource occasion and the first BWP of the set of multiple BWPs, the FMCW signal. The operations of 1515 may be performed in accordance with examples as disclosed herein. In some examples, aspects of the operations of 1515 may be performed by an FMCW component 935 as described with reference to FIG. 9.

At 1520, the method may include transmitting a report indicating one or more second BWPs of the set of multiple BWPs of the wideband based on a channel estimation procedure associated with the set of multiple BWPs of the wideband, where the channel estimation procedure is based on the FMCW signal. The operations of 1520 may be performed in accordance with examples as disclosed herein. In some examples, aspects of the operations of 1520 may be performed by a reporting component 940 as described with reference to FIG. 9.

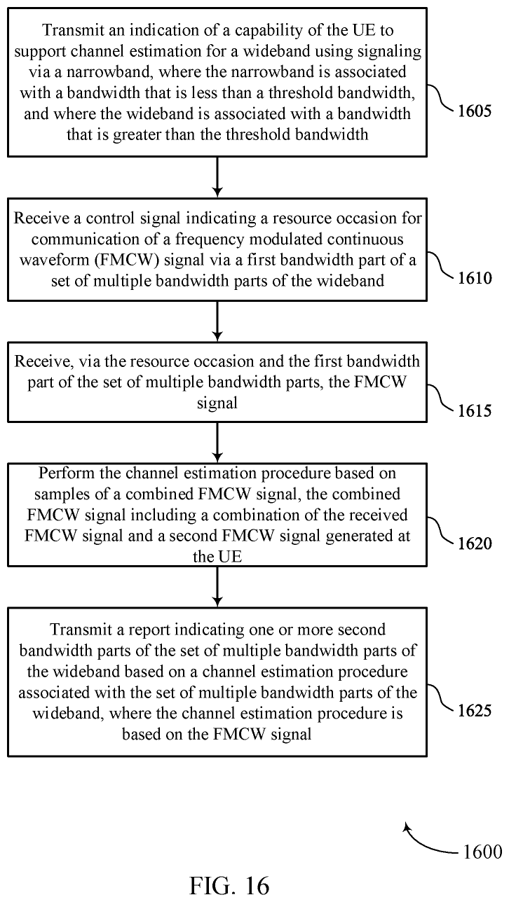

FIG. 16 illustrates a flowchart showing a method 1600 that supports BWP selection using FMCW-based OFDM channel estimation in accordance with one or more aspects of the present disclosure. The operations of the method 1600 may be implemented by a UE or its components as described herein. For example, the operations of the method 1600 may be performed by a UE 115 as described with reference to FIGS. 1 through 10. In some examples, a UE may execute a set of instructions to control the functional elements of the UE to perform the described functions. Additionally, or alternatively, the UE may perform aspects of the described functions using special-purpose hardware.

At 1605, the method may include transmitting an indication of a capability of the UE to support channel estimation for a wideband using signaling via a narrowband, where the narrowband is associated with a bandwidth that is less than a threshold bandwidth, and where the wideband is associated with a bandwidth that is greater than the threshold bandwidth. The operations of 1605 may be performed in accordance with examples as disclosed herein. In some examples, aspects of the operations of 1605 may be performed by a capability component 925 as described with reference to FIG. 9.

At 1610, the method may include receiving a control signal indicating a resource occasion for communication of a FMCW signal via a first BWP of a set of multiple BWPs of the wideband. The operations of 1610 may be performed in accordance with examples as disclosed herein. In some examples, aspects of the operations of 1610 may be performed by a resource component 930 as described with reference to FIG. 9.

At 1615, the method may include receiving, via the resource occasion and the first BWP of the set of multiple BWPs, the FMCW signal. The operations of 1615 may be performed in accordance with examples as disclosed herein. In some examples, aspects of the operations of 1615 may be performed by an FMCW component 935 as described with reference to FIG. 9.

At 1620, the method may include performing the channel estimation procedure based on samples of a combined FMCW signal, the combined FMCW signal including a combination of the received FMCW signal and a second FMCW signal generated at the UE. The operations of 1620 may be performed in accordance with examples as disclosed herein. In some examples, aspects of the operations of 1620 may be performed by a channel estimation component 950 as described with reference to FIG. 9.

At 1625, the method may include transmitting a report indicating one or more second BWPs of the set of multiple BWPs of the wideband based on a channel estimation procedure associated with the set of multiple BWPs of the wideband, where the channel estimation procedure is based on the FMCW signal. The operations of 1625 may be performed in accordance with examples as disclosed herein. In some examples, aspects of the operations of 1625 may be performed by a reporting component 940 as described with reference to FIG. 9.

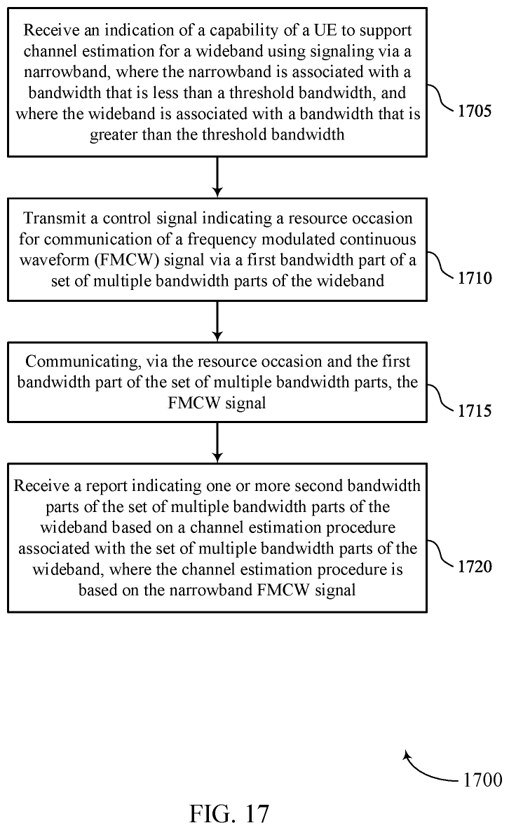

FIG. 17 illustrates a flowchart showing a method 1700 that supports BWP selection using FMCW-based OFDM channel estimation in accordance with one or more aspects of the present disclosure. The operations of the method 1700 may be implemented by a network entity or its components as described herein. For example, the operations of the method 1700 may be performed by a network entity as described with reference to FIGS. 1 through 6 and 11 through 14. In some examples, a network entity may execute a set of instructions to control the functional elements of the network entity to perform the described functions. Additionally, or alternatively, the network entity may perform aspects of the described functions using special-purpose hardware.

At 1705, the method may include receiving an indication of a capability of a UE to support channel estimation for a wideband using signaling via a narrowband, where the narrowband is associated with a bandwidth that is less than a threshold bandwidth, and where the wideband is associated with a bandwidth that is greater than the threshold bandwidth. The operations of 1705 may be performed in accordance with examples as disclosed herein. In some examples, aspects of the operations of 1705 may be performed by a capability component 1325 as described with reference to FIG. 13.

At 1710, the method may include transmitting a control signal indicating a resource occasion for communication of a FMCW signal via a first BWP of a set of multiple BWPs of the wideband. The operations of 1710 may be performed in accordance with examples as disclosed herein. In some examples, aspects of the operations of 1710 may be performed by a configuration component 1330 as described with reference to FIG. 13.

At 1715, the method may include communicating, via the resource occasion and the first BWP of the set of multiple BWPs, the FMCW signal. The operations of 1715 may be performed in accordance with examples as disclosed herein. In some examples, aspects of the operations of 1715 may be performed by an FMCW component 1335 as described with reference to FIG. 13.

At 1720, the method may include receiving a report indicating one or more second BWPs of the set of multiple BWPs of the wideband based on a channel estimation procedure associated with the set of multiple BWPs of the wideband, where the channel estimation procedure is based on the narrowband FMCW signal. The operations of 1720 may be performed in accordance with examples as disclosed herein. In some examples, aspects of the operations of 1720 may be performed by a reporting component 1340 as described with reference to FIG. 13.

The following provides an overview of aspects of the present disclosure:

Aspect 1: A method for wireless communications at a UE, comprising: transmitting an indication of a capability of the UE to support channel estimation for a wideband using signaling via a narrowband, wherein the narrowband is associated with a bandwidth that is less than a threshold bandwidth, and wherein the wideband is associated with a bandwidth that is greater than the threshold bandwidth; receiving a control signal indicating a resource occasion for communication of a FMCW signal via a first BWP of a plurality of BWPs of the wideband; receiving, via the resource occasion and the first BWP of the plurality of BWPs, the FMCW signal; and transmitting a report indicating one or more second BWPs of the plurality of BWPs of the wideband based at least in part on a channel estimation procedure associated with the plurality of BWPs of the wideband, wherein the channel estimation procedure is based at least in part on the FMCW signal.

Aspect 2: The method of aspect 1, wherein transmitting the indication of the capability of the UE comprises: transmitting an indication of one or more time thresholds associated with switching from receiving a first type of signaling to receiving a second type of signaling, switching from receiving the second type of signaling to receiving the first type of signaling, performing the channel estimation procedure, or any combination thereof.

Aspect 3: The method of aspect 2, wherein the first type of signaling is FMCW signaling and the second type of signaling is OFDM signaling.

Aspect 4: The method of any of aspects 1 through 3, wherein receiving the indication of the resource occasion comprises: receiving an indication of a start time, a start frequency, a duration, a bandwidth, a slope, or any combination thereof, associated with the FMCW signal, wherein the resource occasion is based at least in part on the start time, the start frequency, the duration, the bandwidth, the slope, or any combination thereof.

Aspect 5: The method of aspect 4, wherein the duration comprises one or more symbol lengths, a portion of a symbol length, one or more slot lengths, a portion of a slot length, a length of a CP, or any combination thereof.

Aspect 6: The method of any of aspects 1 through 5, further comprising: receiving an indication of one or more resources associated with communicating the report indicating one or more second BWPs, wherein the report is transmitted via the one or more resources.

Aspect 7: The method of aspect 6, wherein the control signal comprises the indication of the one or more resources.

Aspect 8: The method of any of aspects 6 through 7, wherein the indication of the one or more resources is received via a second control signal, the second control signal comprises DCI, a MAC-CE, or RRC signaling.

Aspect 9: The method of any of aspects 1 through 8, further comprising: receiving a second control signal indicating a set of BWP configurations, wherein the report comprises an indication of a first BWP configuration from the set of BWP configurations, and wherein the first BWP configuration is associated with the one or more second BWPs.

Aspect 10: The method of any of aspects 1 through 9, wherein the control signal comprises DCI, a MAC-CE, or a RRC signal.

Aspect 11: The method of any of aspects 1 through 10, wherein the control signal is a dynamic indication of the resource occasion or a semi-persistent indication of the resource occasion.

Aspect 12: The method of any of aspects 1 through 11, further comprising: performing the channel estimation procedure based at least in part on samples of a combined FMCW signal, the combined FMCW signal comprising a combination of the received FMCW signal and a second FMCW signal generated at the UE.

Aspect 13: The method of aspect 12, wherein performing the channel estimation procedure comprises: estimating the plurality of BWPs of the wideband based at least in part on extracting the wideband from the combined FMCW signal.

Aspect 14: The method of any of aspects 12 through 13, wherein the received FMCW signal is associated with the wideband, and the combined FMCW signal is associated with the narrowband.

Aspect 15: The method of any of aspects 1 through 14, further comprising: receiving a second control signal indicating at least one BWP of the one or more second BWPs based at least in part on the report; and communicating via the at least one BWP of the one or more second BWPs.

Aspect 16: The method of any of aspects 1 through 15, wherein the first BWP is of one or more BWPs associated with the narrowband.

Aspect 17: A method for wireless communications at a network entity, comprising: receiving an indication of a capability of a UE to support channel estimation for a wideband using signaling via a narrowband, wherein the narrowband is associated with a bandwidth that is less than a threshold bandwidth, and wherein the wideband is associated with a bandwidth that is greater than the threshold bandwidth; transmitting a control signal indicating a resource occasion for communication of a FMCW signal via a first BWP of a plurality of BWPs of the wideband; communicating, via the resource occasion and the first BWP of the plurality of BWPs, the FMCW signal; and receiving a report indicating one or more second BWPs of the plurality of BWPs of the wideband based at least in part on a channel estimation procedure associated with the plurality of BWPs of the wideband, wherein the channel estimation procedure is based at least in part on the narrowband FMCW signal.

Aspect 18: The method of aspect 17, wherein receiving the indication of the capability of the UE comprises: receiving an indication of one or more time thresholds associated with switching from receiving a first type of signaling to receiving a second type of signaling, switching from receiving the second type of signaling to receiving the first type of signaling, performing the channel estimation procedure, or any combination thereof.

Aspect 19: The method of aspect 18, wherein the first type of signaling is FMCW signaling and the second type of signaling is OFDM signaling.

Aspect 20: The method of any of aspects 17 through 19, wherein transmitting the indication of the resource occasion comprises: transmitting an indication of a start time, a start frequency, a duration, a bandwidth, a slope, or any combination thereof, associated with the FMCW signal, wherein the resource occasion is based at least in part on the start time, the start frequency, the duration, the bandwidth, the slope, or any combination thereof.

Aspect 21: The method of aspect 20, wherein the duration comprises one or more symbol lengths, a portion of a symbol length, one or more slot lengths, a portion of a slot length, a length of a CP, or any combination thereof.

Aspect 22: The method of any of aspects 17 through 21, further comprising: transmitting an indication of one or more resources associated with communicating the report indicating one or more second BWPs, wherein the report is received via the one or more resources.

Aspect 23: The method of aspect 22, wherein the control signaling comprises the indication of the one or more resources.

Aspect 24: The method of any of aspects 22 through 23, wherein the indication of the one or more resources is received via a second control signal, the second control signal comprises DCI, a MAC-CE, or RRC signaling.

Aspect 25: The method of any of aspects 17 through 24, further comprising: transmitting a second control signal indicating a set of BWP configurations, wherein the report comprises an indication of a first BWP configuration from the set of BWP configurations, and wherein the first BWP configuration is associated with the one or more second BWPs.

Aspect 26: The method of any of aspects 17 through 25, wherein the control signal comprises DCI, a MAC-CE, or a RRC signal.

Aspect 27: The method of any of aspects 17 through 26, wherein the control signal comprises a dynamic indication of the resource occasion or a semi-persistent indication of the resource occasion.

Aspect 28: The method of any of aspects 17 through 27, wherein the FMCW signal is communicated via unicast, groupcast, broadcast, or multicast.

Aspect 29: The method of any of aspects 17 through 28, further comprising: transmitting a second control signal indicating at least one BWP of the one or more second BWPs based at least in part on the report; and communicating via the at least one BWP of the one or more second BWPs.

Aspect 30: The method of any of aspects 17 through 29, wherein the first BWP is of one or more BWPs associated with the narrowband.

Aspect 31: An apparatus for wireless communications at a UE, comprising a processor; memory coupled with the processor; and instructions stored in the memory and executable by the processor to cause the apparatus to perform a method of any of aspects 1 through 16.

Aspect 32: An apparatus for wireless communications at a UE, comprising at least one means for performing a method of any of aspects 1 through 16.

Aspect 33: A non-transitory computer-readable medium storing code for wireless communications at a UE, the code comprising instructions executable by a processor to perform a method of any of aspects 1 through 16.

Aspect 34: An apparatus for wireless communications at a network entity, comprising a processor; memory coupled with the processor; and instructions stored in the memory and executable by the processor to cause the apparatus to perform a method of any of aspects 17 through 30.

Aspect 35: An apparatus for wireless communications at a network entity, comprising at least one means for performing a method of any of aspects 17 through 30.

Aspect 36: A non-transitory computer-readable medium storing code for wireless communications at a network entity, the code comprising instructions executable by a processor to perform a method of any of aspects 17 through 30.

It should be noted that the methods described herein describe possible implementations, and that the operations and the steps may be rearranged or otherwise modified and that other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc. Disks may reproduce data magnetically, and discs may reproduce data optically using lasers.

Combinations of the above are also included within the scope of computer-readable media.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.” The term “determine” or “determining” encompasses a variety of actions and, therefore, “determining” can include calculating, computing, processing, deriving, investigating, looking up (such as via looking up in a table, a database or another data structure), ascertaining and the like. Also, “determining” can include receiving (e.g., receiving information), accessing (e.g., accessing data stored in memory) and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

1. An apparatus for wireless communications at a user equipment (UE), comprising:
a processor;
memory coupled with the processor; and
instructions stored in the memory and executable by the processor to cause the apparatus to:
transmit an indication of a capability of the UE to support channel estimation for a wideband using signaling via a narrowband, wherein the narrowband is associated with a bandwidth that is less than a threshold bandwidth, and wherein the wideband is associated with a bandwidth that is greater than the threshold bandwidth;
receive a control signal indicating a resource occasion for communication of a frequency modulated continuous waveform (FMCW) signal via a first bandwidth part of a plurality of bandwidth parts of the wideband;
receive, via the resource occasion and the first bandwidth part of the plurality of bandwidth parts, the FMCW signal; and
transmit a report indicating one or more second bandwidth parts of the plurality of bandwidth parts of the wideband based at least in part on a channel estimation procedure associated with the plurality of bandwidth parts of the wideband, wherein the channel estimation procedure is based at least in part on the FMCW signal.

2. The apparatus of claim 1, wherein the instructions to transmit the indication of the capability of the UE are executable by the processor to cause the apparatus to:
transmit an indication of one or more time thresholds associated with switching from receiving a first type of signaling to receiving a second type of signaling, switching from receiving the second type of signaling to receiving the first type of signaling, performing the channel estimation procedure, or any combination thereof.

3. The apparatus of claim 2, wherein the first type of signaling is FMCW signaling and the second type of signaling is orthogonal frequency division multiplexing (OFDM) signaling.

4. The apparatus of claim 1, wherein the instructions to receive the indication of the resource occasion are executable by the processor to cause the apparatus to:
receive an indication of a start time, a start frequency, a duration, a bandwidth, a slope, or any combination thereof, associated with the FMCW signal, wherein the resource occasion is based at least in part on the start time, the start frequency, the duration, the bandwidth, the slope, or any combination thereof.

5. The apparatus of claim 4, wherein the duration comprises one or more symbol lengths, a portion of a symbol length, one or more slot lengths, a portion of a slot length, a length of a cyclic prefix, or any combination thereof.

6. The apparatus of claim 1, wherein the instructions are further executable by the processor to cause the apparatus to:
receive an indication of one or more resources associated with communicating the report indicating one or more second bandwidth parts, wherein the report is transmitted via the one or more resources.

7. The apparatus of claim 6, wherein the control signal comprises the indication of the one or more resources.

8. The apparatus of claim 6, wherein the indication of the one or more resources is received via a second control signal, and wherein the second control signal comprises downlink control information, a medium access control-control element, or radio resource control signaling.

9. The apparatus of claim 1, wherein the instructions are further executable by the processor to cause the apparatus to:
receive a second control signal indicating a set of bandwidth part configurations, wherein the report comprises an indication of a first bandwidth part configuration from the set of bandwidth part configurations, and wherein the first bandwidth part configuration is associated with the one or more second bandwidth parts.

10. The apparatus of claim 1, wherein the control signal is a dynamic indication of the resource occasion or a semi-persistent indication of the resource occasion.

11. The apparatus of claim 1, wherein the instructions are further executable by the processor to cause the apparatus to:
perform the channel estimation procedure based at least in part on samples of a combined FMCW signal, the combined FMCW signal comprising a combination of the received FMCW signal and a second FMCW signal generated at the UE.

12. The apparatus of claim 11, wherein the instructions to perform the channel estimation procedure are executable by the processor to cause the apparatus to:
estimate the plurality of bandwidth parts of the wideband based at least in part on extracting the wideband from the combined FMCW signal.

13. The apparatus of claim 11, wherein the received FMCW signal is associated with the wideband, and wherein the combined FMCW signal is associated with the narrowband.

14. The apparatus of claim 1, wherein the instructions are further executable by the processor to cause the apparatus to:
receive a second control signal indicating at least one bandwidth part of the one or more second bandwidth parts based at least in part on the report; and
communicating via the at least one bandwidth part of the one or more second bandwidth parts.

15. The apparatus of claim 1, wherein the first bandwidth part is of one or more bandwidth parts associated with the narrowband.

16. An apparatus for wireless communications at a network entity, comprising:
a processor;
memory coupled with the processor; and
instructions stored in the memory and executable by the processor to cause the apparatus to:
receive an indication of a capability of a user equipment (UE) to support channel estimation for a wideband using signaling via a narrowband, wherein the narrowband is associated with a bandwidth that is less than a threshold bandwidth, and wherein the wideband is associated with a bandwidth that is greater than the threshold bandwidth;
transmit a control signal indicating a resource occasion for communication of a frequency modulated continuous waveform (FMCW) signal via a first bandwidth part of a plurality of bandwidth parts of the wideband;
communicating, via the resource occasion and the first bandwidth part of the plurality of bandwidth parts, the FMCW signal; and
receive a report indicating one or more second bandwidth parts of the plurality of bandwidth parts of the wideband based at least in part on a channel estimation procedure associated with the plurality of bandwidth parts of the wideband, wherein the channel estimation procedure is based at least in part on the narrowband FMCW signal.

17. The apparatus of claim 16, wherein the instructions to receive the indication of the capability of the UE are executable by the processor to cause the apparatus to:
receive an indication of one or more time thresholds associated with switching from receiving a first type of signaling to receiving a second type of signaling, switching from receiving the second type of signaling to receiving the first type of signaling, performing the channel estimation procedure, or any combination thereof.

18. The apparatus of claim 17, wherein the first type of signaling is FMCW signaling and the second type of signaling is orthogonal frequency division multiplexing (OFDM) signaling.

19. The apparatus of claim 16, wherein the instructions to transmit the indication of the resource occasion are executable by the processor to cause the apparatus to:
transmit an indication of a start time, a start frequency, a duration, a bandwidth, a slope, or any combination thereof, associated with the FMCW signal, wherein the resource occasion is based at least in part on the start time, the start frequency, the duration, the bandwidth, the slope, or any combination thereof.

20. The apparatus of claim 19, wherein the duration comprises one or more symbol lengths, a portion of a symbol length, one or more slot lengths, a portion of a slot length, a length of a cyclic prefix, or any combination thereof.

21-30. (canceled)
